(19) United States
(12) Patent Application Publication
(10) Pub. No.: US 2024/0031219 A1
(43) Pub. Date: Jan. 25, 2024

(54) METHODS AND APPARATUS FOR MAPPING ACTIVE ASSURANCE INTENTS TO RESOURCE ORCHESTRATION AND LIFE CYCLE MANAGEMENT

(71) Applicant: Intel Corporation, Santa Clara, CA (US)

(72) Inventors: John J. Browne, Limerick (IE); Kshitij Arun Doshi, Tempe, AZ (US); Francesc Guim Bernat, Barcelona (ES); Adrian Hoban, Cratloe (IE); Mats Agerstam, Portland, OR (US); Shekar Ramachandran, Bangalore (IN); Thijs Metsch, Bruehl (DE); Timothy Verrall, Pleasant Hill, CA (US); Ciara Loftus, Tuam (IE); Emma Collins, Limerick (IE); Krzysztof Kepka, Gdansk (PL); Pawel Zak, Gdansk (PL); Aibhne Breathnach, Waterford (IE); Ivens Zambrano, Ennis (IE); Shanshu Yang, Dublin (IE)

(21) Appl. No.: 18/478,514

(22) Filed: Sep. 29, 2023

(51) Int. Cl. H04L 41/0654; H04L 41/0806

(52) U.S. Cl. CPC H04L 41/0654; H04L 41/0806

(57) ABSTRACT

Methods, apparatus, and systems are disclosed for mapping active assurance intents to resource orchestration and life cycle management. An example apparatus disclosed herein is to reserve a probe on a compute device in a cluster of compute devices based on a request to satisfy a resource availability criterion associated with a resource of the cluster, apply a risk mitigation operation based on the resource availability criterion before deployment of a workload to the cluster, and monitor whether the criterion is satisfied based on data from the probe after deployment of the workload to the cluster.

### FIELD OF THE DISCLOSURE

This disclosure relates generally to software processing, and, more particularly, to methods, systems, and apparatus for mapping active assurance intents to resource orchestration and life cycle management.

### BACKGROUND

Edge environments (e.g., an Edge, Fog, multi-access edge computing (MEC), or Internet of Things (IoT) network) enable workload execution (e.g., execution of one or more computing tasks, execution of a machine learning model using input data, etc.) near endpoint devices that request an execution of the workload. Edge environments may include infrastructure, such as an edge platform, that is connected to cloud infrastructure, endpoint devices, and/or additional edge infrastructure via networks such as the Internet. Edge platforms may be closer in proximity to endpoint devices than cloud infrastructure, such as centralized servers.

### BRIEF DESCRIPTION OF THE DRAWINGS

FIG. 1 is an example diagram indicating platform-based intents (e.g., performance, dependability, security, sustainability, etc.) based on service owner and resource owner preferences.

FIG. 2 depicts an example environment showing implementation of an edge platform used to process workloads.

FIG. 3 is a block diagram representative of example edge platform circuitry that may be implemented in the example environment of FIG. 2.

FIG. 4 is a block diagram representative of example orchestrator controller circuitry associated with the edge platform circuitry of FIG. 3.

FIG. 5 is a flowchart representative of example machine-readable instructions and/or example operations that may be executed, instantiated, and/or performed by example programmable circuitry to implement the example orchestrator controller circuitry of FIG. 4.

FIG. 6 is a flowchart representative of example machine-readable instructions and/or example operations that may be executed, instantiated, and/or performed by example programmable circuitry to implement the example orchestrator controller circuitry of FIG. 4 to map assurance intents and evaluate intent-based assurance effectiveness in accordance with teachings disclosed herein.

FIG. 7 is a flowchart representative of example machine readable instructions and/or example operations that may be executed, instantiated, and/or performed by example programmable circuitry to cause a first example computing system of FIG. 4 to train a neural network to generate resource reservation model(s).

FIG. 8 is a flowchart representative of example machine-readable instructions and/or example operations that may be executed, instantiated, and/or performed by example programmable circuitry to implement the example orchestrator controller circuitry of FIG. 4 to perform risk mitigation in accordance with teachings disclosed herein.

FIG. 9 is a flowchart representative of example machine readable instructions and/or example operations that may be executed, instantiated, and/or performed by example programmable circuitry to cause a second example computing system of FIG. 4 to train a neural network to generate risk model(s).

FIG. 10 illustrates an example system diagram used to assess assurance intent violation(s) and assurance score and recommendations in accordance with the machine-readable instructions and/or operations of FIGS. 5-7.

FIG. 11 illustrates example intent-based service level objectives for service assurance, including assessing assurance intent violation(s) and assurance score and recommendations.

FIG. 12 illustrates an example system diagram used to identify risk intent violations and modify risk mitigations in accordance with the machine-readable instructions and/or operations of FIGS. 5, and 8-9.

FIG. 13 illustrates example mitigation of risk based on pre-planned resource allocation, configuration scaling, task migration, and resource sequestrations, including identification of risk intent violations and modification of risk mitigations.

FIG. 14 illustrates example calculated expected costs associated with simple risk management budget allocations.

FIG. 15 is a block diagram of an example processing platform including programmable circuitry structured to execute, instantiate, and/or perform the example machine readable instructions and/or perform the example operations of FIGS. 5-9 to implement the orchestrator controller circuitry of FIG. 4.

FIG. 16 is a block diagram of an example processing platform structured to execute the instructions of FIG. 7 to implement the first computing system of FIG. 4.

FIG. 17 is a block diagram of an example processing platform structured to execute the instructions of FIG. 9 to implement the second computing system of FIG. 4.

FIG. 18 is a block diagram of an example implementation of the programmable circuitry of FIG. 15.

FIG. 19 is a block diagram of another example implementation of the programmable circuitry of FIG. 15.

FIG. 20 is a block diagram of an example software/firmware/instructions distribution platform (e.g., one or more servers) to distribute software, instructions, and/or firmware (e.g., corresponding to the example machine readable instructions of FIGS. 5, 6, 7, 8, and/or 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

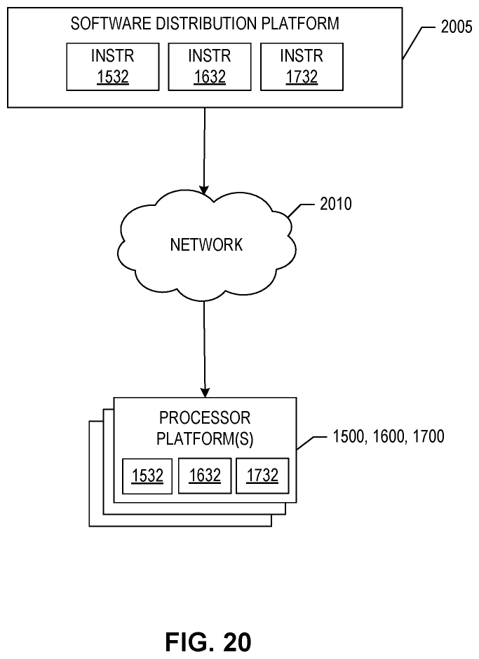

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Edge computing, at a general level, refers to the transition of compute and storage resources closer to endpoint devices (e.g., consumer computing devices, user equipment, etc.) to reduce total cost of ownership, reduce application latency, improve service capabilities, and improve compliance with data privacy or security requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network.

Edge computing use cases in mobile network settings have been developed for integration with multi-access edge computing (MEC) approaches, also known as “mobile edge computing.” MEC approaches are designed to allow application developers and content providers to access computing capabilities and an information technology (IT) service environment in dynamic mobile network settings at the edge of the network. Edge computing, MEC, and related technologies attempt to provide reduced latency, improved responsiveness, and more available computing power than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (e.g., devices, hosts, tenants, service providers, operators, etc.) are involved.

In a similar manner, Internet of Things (IoT) networks and devices are designed to offer a distributed compute arrangement from a variety of endpoints. IoT devices can be physical or virtualized objects that may communicate on a network, and can include sensors, actuators, and/or other input/output components, which may be used to collect data or perform actions in a real-world environment. For example, IoT devices can include low-powered endpoint devices that are embedded or attached to everyday things, such as buildings, vehicles, packages, etc., to provide an additional level of artificial sensory perception of those things. In recent years, IoT devices have become more popular and thus applications using these devices have proliferated.

In some examples, an edge environment can include an enterprise edge in which communication with and/or communication within the enterprise edge can be facilitated via wireless and/or wired connectivity. The deployment of various Edge, Fog, MEC, and IoT networks, devices, and services have introduced a number of advanced use cases and scenarios occurring at and towards the edge of the network. However, these advanced use cases have also introduced a number of corresponding technical challenges relating to security, processing and network resources, service availability and efficiency, among many other issues. One such challenge is in relation to Edge, Fog, MEC, and IoT networks, devices, and services executing workloads on behalf of endpoint devices.

The present techniques and configurations may be utilized in connection with many aspects of current networking systems, but are provided with reference to Edge Cloud, IoT, MEC, and other distributed computing deployments. The following systems and techniques may be implemented in, or augment, a variety of distributed, virtualized, or managed edge computing systems. These include environments in which network services are implemented or managed using MEC, fourth generation (4G) or fifth generation (5G) wireless network configurations; or in wired network configurations involving fiber, copper, and other connections. Further, aspects of processing by the respective computing components may involve computational elements which are in geographical proximity of a user equipment or other endpoint locations, such as a smartphone, vehicular communication component, IoT device, etc. Further, the presently disclosed techniques may relate to other Edge/MEC/IoT network communication standards and configurations, and other intermediate processing entities and architectures.

Edge computing is a developing paradigm where computing is performed at or closer to the “edge” of a network, typically through the use of computing platforms implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. As another example, base stations may be augmented with compute and acceleration resources to directly process service workloads for connected user equipment, without further communicating data via backhaul networks. As another example, central office network management hardware may be replaced with computing hardware that performs virtualized network functions and offers compute resources for the execution of services and consumer functions for connected devices.

Edge environments include networks and/or portions of networks that are located between a cloud environment and an endpoint environment. Edge environments enable computations of workloads at edges of a network. For example, an endpoint device may request a nearby base station to compute a workload rather than a central server in a cloud environment. Edge environments include edge platforms, which include pools of memory, storage resources, and/or processing resources. Edge platforms perform computations, such as an execution of a workload, on behalf of other edge platforms and/or edge nodes. Edge environments facilitate connections between producers (e.g., workload executors, edge platforms) and consumers (e.g., other edge platforms, endpoint devices).

Because edge platforms may be closer in proximity to endpoint devices than centralized servers in cloud environments, edge platforms enable computations of workloads with a lower latency (e.g., response time) than cloud environments. Edge platforms may also enable a localized execution of a workload based on geographic locations or network topographies. For example, an endpoint device may require a workload to be executed in a first geographic area, but a centralized server may be located in a second geographic area. The endpoint device can request a workload execution by an edge platform located in the first geographic area to comply with corporate or regulatory restrictions.

Examples of workloads to be executed in an edge environment include autonomous driving computations, video surveillance monitoring, machine learning model executions, and real time data analytics. Additional examples of workloads include delivering and/or encoding media streams, measuring advertisement impression rates, object detection in media streams, speech analytics, asset and/or inventory management, and augmented reality processing.

Edge platforms enable both the execution of workloads and a return of a result of an executed workload to endpoint devices with a response time lower than the response time of a server in a cloud environment. For example, if an edge platform is located closer to an endpoint device on a network than a cloud server, the edge service may respond to workload execution requests from the endpoint device faster than the cloud server. An endpoint device may request an execution of a time-constrained workload from an edge service rather than a cloud server.

In addition, edge platforms enable the distribution and decentralization of workload executions. For example, an endpoint device may request a first workload execution and a second workload execution. In some examples, a cloud server may respond to both workload execution requests. With an edge environment, however, a first edge platform may execute the first workload execution request, and a second edge platform may execute the second workload execution request.

To meet the low-latency and high-bandwidth demands of endpoint devices, orchestration in edge clouds is performed on the basis of timely information about the utilization of many resources (e.g., hardware resources, software resources, virtual hardware and/or software resources, etc.), and the efficiency with which those resources are able to meet the demands placed on them. Such timely information is generally referred to as telemetry (e.g., telemetry data, telemetry information, etc.).

Telemetry can be generated from a plurality of sources including each hardware component or portion thereof, virtual machines (VMs), operating systems (OSes), applications, and orchestrators. Telemetry can be used by orchestrators, schedulers, etc., to determine a quantity, quantities, and/or type of computation tasks to be scheduled for execution at which resource or portion(s) thereof, and an expected time to completion of such computation tasks based on historical and/or current (e.g., instant or near-instant) telemetry. For example, a core of a multi-core central processing unit (CPU) can generate over a thousand different varieties of information every fraction of a second using a performance monitoring unit (PMU) sampling the core and/or, more generally, the multi-core CPU. Periodically aggregating and processing all such telemetry in a given edge platform, edge node, etc., can be an arduous and cumbersome process. Prioritizing salient features of interest and extracting such salient features from telemetry to identify current or future problems, stressors, etc., associated with a resource is difficult. Furthermore, identifying a different resource to offload workloads from a burdened resource is a complex undertaking.

Some edge environments desire to obtain telemetry data associated with resources executing a variety of functions or services, such as data processing or video analytics functions (e.g., machine vision, image processing for autonomous vehicle, facial recognition detection, visual object detection, etc.). However, many high-throughput workloads, including one or more video analytics functions, may execute for less than a millisecond (or other relatively small time duration). Such edge environments do not have distributed monitoring software or hardware solutions or a combination thereof that are capable of monitoring such highly-granular stateless functions that are executed on a platform (e.g., a resource platform, a hardware platform, a software platform, a virtualized platform, etc.).

Many edge environments include a diversity of components for resource management and orchestration. Such edge environments may employ static orchestration when deciding on placement of services and workload at specific edge platforms and perform service level agreement monitoring of the applications and/or services in an any-cost framework. An any-cost framework includes orchestration components that manage resources and services at an edge platform but do not consider the computational costs associated with the orchestration components. Additionally, an any-cost framework includes orchestration components that are not responsive to the availability of computational resources and power to perform operations associated with those orchestration resources. Thus, edge environments may include orchestration resources that are inelastic and consume resources of an edge platform in a non-proportionate manner with respect to the resources and power that they manage. Additionally, edge environments may not include orchestration components that can be executed at an accelerator. The any-cost framework of existing components is a vulnerability (e.g., a glass jaw) of most edge environments. Orchestration components in most edge environments focus on optimizing resource utilization(s) of services and/or application executing at an edge platform and meeting application and/or workload service level agreements (SLAs).

In today's orchestration solutions, much of the focus is around requesting the correct quantity of resources (e.g., number of vCPUs), or abstracting hardware capabilities (e.g., such as Resource Director Technology (RDT), Running Average Power Limit (RAPL), Hardware Controlled Performance (HWP)) to facilitate their use by Quality of Service (QoS) software. However, issues with such imperative approaches include (1) unwanted vendor lock-in results as the communications service providers (CSPs) decide what to expose and how, (2) declaration of incorrect information leading to sub-optimal performance, and (2) limited to no awareness by applications and workload cohorts of critical details (e.g., where a Xeon® versus Atom® has much performance impact and where other cores/threads can unintentionally produce hidden interferences in shared resources like core-to-uncore queues, which cannot be easily controlled only through RDT). Furthermore, as applications transform from monolithic to microservices style, customers' burden of selecting the right cost versus responsiveness versus throughput becomes complicated and is made even more difficult as memory and computation become heterogeneous. It becomes essential to unburden users from the responsibility of having to detail how various desired assurances are to be met, and instead, to focus directly on resource-mapping, monitoring, evaluating, and controlling outcomes for the assurances that need to be met.

In some examples, customers need a way to map assurance intents to service orchestration and resource orchestration, which includes reservation of resources for ‘on-demand’dynamic service assurance probes (e.g., assuring the operation of a 5G core and actively assessing root cause issues using both passive and active assurance methods). In some examples, customers need a method to evaluate intent-based assurance effectiveness and generate an alert when an assurance intent is not met. For example, when workloads are deployed, the monitoring, orchestration and analytics stacks can be in many different failed states, preventing assurance. Failed states can be identified as (1) not-deployed, (2) failed, (3) unreachable, (4) unable to support, or respond to in a timely manner, active probes, (5) platform telemetry unavailable, and/or (6) orchestration system telemetry interface (e.g., cluster metrics) not available. Some methods have focused on deploying a dedicated platform to contain dynamic probes as an attempt to guarantee platform availability for probes to be deployed in the future. Other methods have focused on using Kubernetes or other container or application orchestration engine to deploy active probes to a platform providing a service. However, dedicating an entire server to probes that may be deployed in the future is wasteful and/or resources in a datacenter/cloud deployment and extra resources are not available at the edge of the network. Furthermore, considering dedicated servers, software and probes need to change as more advanced platforms enter deployment (e.g., a solution with active probes on dedicated servers of a first type may need to be reworked considerably when a server of a second type is an improved choice with significant performance and acceleration options). In some examples, Kubernetes may not have compute resources available to deploy on-demand probes when required. Additionally, an impact of responsiveness versus resource/traffic overhead of using on-demand probes in the cluster is another factor that needs consideration.

Example methods and apparatus disclosed herein facilitate forced reservation for active probes and introduce a new workflow to perform a series of automated checks. In at least some examples disclosed herein, a new workflow is introduced to prioritize deploying an active probe by forcefully freeing up capacity through a combination of forced scaling down of deployed workload capacity (e.g., apart from the workload under test), temporarily evicting other workloads, and/or adding capacity to the workload under test to possibly deploy the active probe with a sidecar pattern. In some examples, policy governance can be used to decide whether a permanent reserve or forceful deploy pattern can be used. Furthermore, in at least some examples disclosed herein, a new workflow to perform a series of automated checks is introduced based on a predefined policy, which defines the required assurance capabilities including: (1) platform collectors deployed and active, (2) platform collector reachable, (3) monitoring system deployed, (4) monitoring system accessible, (5) reserved space for active probes available, (6) Kubernetes (K8S) cluster accessible, (7) K8S ingress load balancer available, (8) cluster telemetry service available and reachable, (9) monitoring and analytics system platform fault count within tolerance, and/or (10) software-defined networking (SDN) system available. For example, monitoring and automatic checks can be performed using network schemes (e.g., infrastructure processing units (IPUs) and switches) to have more complex triggering rules. For example, a scale-out application may be acceptable if certain services fail or have a transient failure. However, a high risk of application failure can occur if both services have transient connectivity failure at the same time. Therefore, network schemes (e.g., IPUs and switches) can be programmed to monitor such a multi-modal dependency.

Additionally, risk management computation can be complex and associated with context and intention dependent weights assigned to different events, outages, and service level objectives (SLOs). An intention-based orchestration policy can automate and prioritize dynamically the allocation of risk budget by taking various known and emerging predictors (e.g., factors, observations) and mitigate risk by calling into pre-planned resource allocation, configuration scaling, task migration, and resource sequestration policies. It can also raise alerts as-and-when such dynamically managed risk budget crosses thresholds and requires human attention. For example, reactive site reliability engineering (SIZE) risk management can be brought under the rubric of intent-based orchestration.

Example methods and apparatus disclosed herein additionally or alternatively facilitate mapping a risk intent to deployment methods and mitigations. In at least some examples disclosed herein, risk mitigations generation includes expressing the risk as a probability of occurrence and impact, expressed as a cost value, with impact to end users and the cost to repair used as inputs. The risk assessment component builds models of risks overtime, based in observed risk occurrence, impact and meantime to repair and produces a model for each layer of the stack. Risk models are produced for faults in the orchestration layer, infrastructure layer, service orchestration layer, monitor and analytics layer, etc. In at least some examples disclosed herein, the service to be deployed provides an intent-based risk tolerance profile/descriptor, that includes (1) allowable outage time, (2) time to repair, (3) cost to repair, (4) allowable number of users to be impacted, and/or (5) degradation allowable on app specific SLOs. For example, applying risk mitigations includes considering the risk profile and distributing risk to each layer of the stack and to specific resources. In at least some examples, highly reliable resources are matched to risk intents that have the largest impact on cost and the lowest tolerance to outage time. The effectiveness of mitigations is monitored and evaluated over time. Given that not all risk assessments are sufficiently accurate for high confidence, at least some examples disclosed herein collect data on faults and numbers of interactions that are impacted by faults so that divergence of actual risk (e.g., as measured by a cost function of impacts) from projected risk can be used in retraining the risk assessments and for focusing postmortem analyses and adapting escalations. The risk model disclosed herein for generating risk mitigations can be continually updated using this approach. In at least some examples disclosed herein, risk hierarchy and risk relationships can be built into the models supporting an up leveling of risk from lower layers of the stack to higher layers. This modeling allows for an impact (e.g., blast radius) to be associated with certain risks.

In at least some examples disclosed herein, risk mitigations are part of the risk model and the mitigations can be expressed as intents (e.g., user desires to mitigate high impact risks, application of automatic remediations, and notification of human operators when remediations do not work). Mitigations can include adding more capacity on failure conditions, among others (e.g., 1+N, 1:1, protection schemes, path rerouting to alternate sites, etc.). Risk model updates (e.g., reputation) can be part of an attestation architecture such that trust can be not only established, but also validated. In at least some examples disclosed herein, declarative means of specifying extended telemetry are provided to assess whether those mitigations help, and to what extent. For example, mitigations may take some time to work and may produce temporary but acceptable setbacks (e.g., more latency, less throughput, etc.) before they produce improvements.

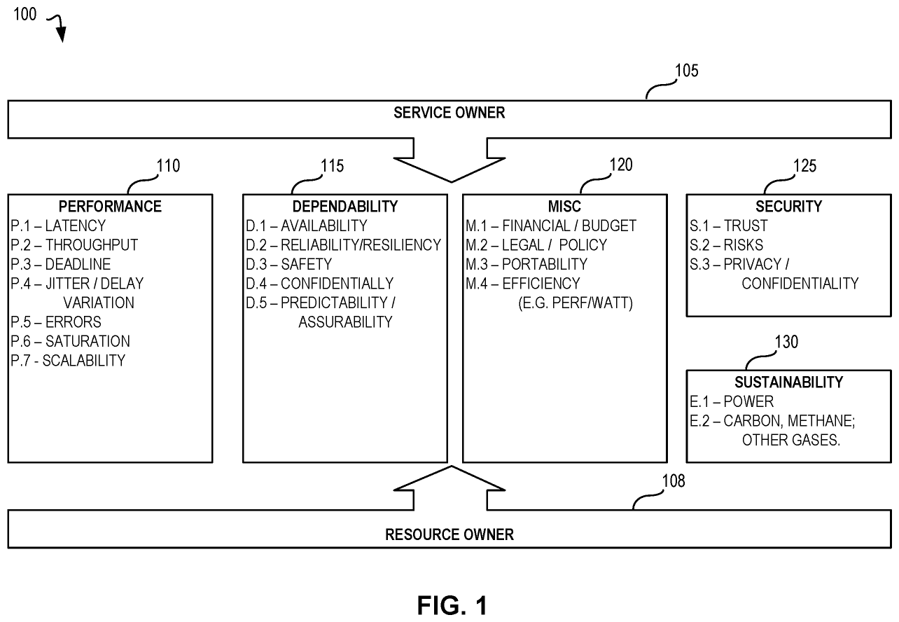

FIG. 1 is an example diagram 100 indicating platform-based intents (e.g., performance, dependability, security, sustainability, etc.) based on example service owner preferences 105 and example resource owner preferences 108. Such preferences can be categorized as example performance outcomes 110, example dependability outcomes 115, example miscellaneous outcomes 120, example security outcomes 125, and/or example sustainability outcomes 130. For example, performance outcomes 110 can be defined based on latency, throughput, errors, saturation, and/or scalability. Dependability outcomes 115 can be defined based on availability, safety, confidentiality, and/or predictability. Miscellaneous outcomes 120 include financial preferences, portability, and/or efficiency. Security outcomes 125 include trust, risks, and privacy/confidentiality. Sustainability outcomes 130 can include power, as well as carbon and methane gas outputs.

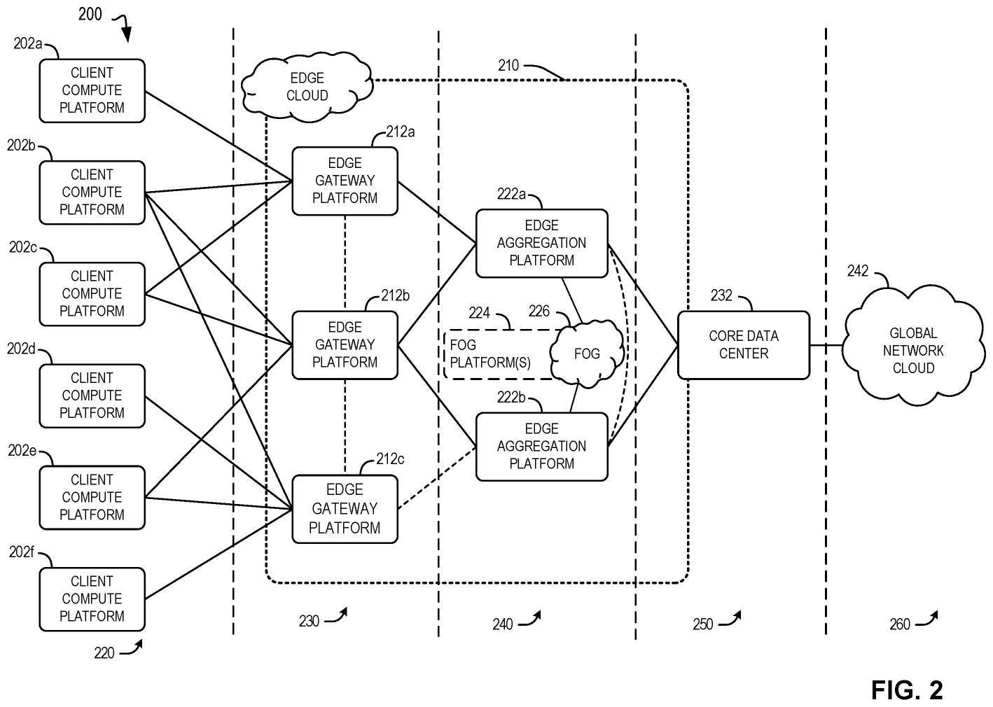

FIG. 2 depicts an example edge computing system 200 used to process workloads. FIG. 2 includes one or more example client compute platforms 202 (e.g., client compute platform(s) 202a, 202b, 202c, 202d, 202e, 2020, one or more example edge gateway platforms 212 (e.g., example edge gateway platform(s) 212a, 212b, 212c), one or more example edge aggregation platforms 222 (e.g., example edge aggregation platform(s) 222a, 222b), one or more example core data centers 232, and an example global network cloud 242, as distributed across layers of the edge computing system 200. The implementation of the edge computing system 200 may be provided at or on behalf of a telecommunication service provider (“telco”, or “TSP”), internet-of-things service provider, cloud service provider (CSP), enterprise entity, or any other number of entities. Various implementations and configurations of the edge computing system 200 may be provided dynamically, such as when orchestrated to meet service objectives.

Individual platforms or devices of the edge computing system 200 are located at a particular layer corresponding to example layers 220, 230, 240, 250, and/or 260. For example, the client compute platforms 202a, 202b, 202c, 202d, 202e, 202f are located at an example endpoint layer 220, while the edge gateway platforms 212a, 212b, 212c are located at an example edge devices layer 230 (local level) of the edge computing system 200. Additionally, the edge aggregation platforms 222a, 222b (and/or fog platform(s) 224, if arranged or operated with or among a fog networking configuration 226) are located at an example network access layer 240 (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

In the example of FIG. 2, the core data center 232 is located at an example core network layer 250 (a regional or geographically central level), while the global network cloud 242 is located at an example cloud data center layer 260 (a national or world-wide layer). The use of “core” is provided as a term for a centralized network location—deeper in the network—which is accessible by multiple edge platforms or components; however, a “core” does not necessarily designate the “center” or the deepest location of the network. Accordingly, the core data center 232 may be located within, at, or near the edge cloud 210. Although an illustrative number of client compute platforms 202a, 202b, 202c, 202d, 202e, 202f; edge gateway platforms 212a, 212b, 212c; edge aggregation platforms 222a, 222b; edge core data centers 232; and global network clouds 242 are shown in FIG. 2, it should be appreciated that the edge computing system 200 may include any number of devices and/or systems at each layer. Devices at any layer can be configured as peer nodes and/or peer platforms to each other and, accordingly, act in a collaborative manner to meet service objectives. For example, in additional or alternative examples, the edge gateway platforms 212a, 212b, 212c can be configured as an edge of edges such that the edge gateway platforms 212a, 212b, 212c communicate via peer-to-peer connections. In some examples, the edge aggregation platforms 222a, 222b and/or the fog platform(s) 224 can be configured as an edge of edges such that the edge aggregation platforms 222a, 222b and/or the fog platform(s) communicate via peer-to-peer connections. Additionally, as shown in FIG. 2, the number of components of respective layers 220, 230, 240, 250, and 260 generally increases at each lower level (e.g., when moving closer to endpoints (e.g., client compute platforms 202a, 202b, 202c, 202d, 202e, 202f)). As such, one edge gateway platforms 212a, 212b, 212c may service multiple ones of the client compute platforms 202a, 202b, 202c, 202d, 202e, 202f, and one edge aggregation platform (e.g., one of the edge aggregation platforms 222a, 222b) may service multiple ones of the edge gateway platforms 212a, 212b, 212c.

Consistent with the examples provided herein, a client compute platform (e.g., one of the client compute platforms 202a, 202b, 202c, 202d, 202e, 2020 may be implemented as any type of endpoint component, device, appliance, or other thing capable of communicating as a producer or consumer of data. For example, a client compute platform can include a mobile phone, a laptop computer, a desktop computer, a processor platform in an autonomous vehicle, etc. In additional or alternative examples, a client compute platform can include a camera, a sensor, etc. Further, the label “platform,” “node,” and/or “device” as used in the edge computing system 200 does not necessarily mean that such platform, node, and/or device operates in a client or slave role; rather, any of the platforms, nodes, and/or devices in the edge computing system 200 refer to individual entities, platforms, nodes, devices, and/or subsystems which include discrete and/or connected hardware and/or software configurations to facilitate and/or use the edge cloud 210.

As such, the edge cloud 210 is formed from network components and functional features operated by and within the edge gateway platforms 212a, 212b, 212c and the edge aggregation platforms 222a, 222b of layers 230, 240, respectively. The edge cloud 210 may be implemented as any type of network that provides edge computing and/or storage resources which are proximately located to radio access network (RAN) capable endpoint devices (e.g., mobile computing devices, IoT devices, smart devices, etc.), which are shown in FIG. 2 as the client compute platforms 202a, 202b, 202c, 202d, 202e, 202f. In other words, the edge cloud 210 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge gateway platforms 212a, 212b, 212c and the edge aggregation platforms 222a, 222b cooperate to provide various edge services and security to the client compute platforms 202a, 202b, 202c, 202d, 202e, 202f. Furthermore, because a client compute platforms (e.g., one of the client compute platforms 202a, 202b, 202c, 202d, 202e, 202f) may be stationary or mobile, a respective edge gateway platform 212a, 212b, 212c may cooperate with other edge gateway platforms to propagate presently provided edge services, relevant service data, and security as the corresponding client compute platforms 202a, 202b, 202c, 202d, 202e, 202f moves about a region. To do so, the edge gateway platforms 212a, 212b, 212c and/or edge aggregation platforms 222a, 222b may support multiple tenancy and multiple tenant configurations, in which services from (or hosted for) multiple service providers, owners, and multiple consumers may be supported and coordinated across single or multiple compute device(s) in a cluster of compute devices.

Additionally, edge platforms and/or orchestration components thereof may consider several factors when orchestrating services and/or applications in an edge environment. These factors can include next-generation central office smart network functions virtualization and service management, improving performance per watt at an edge platform and/or of orchestration components to overcome the limitation of power at edge platforms, reducing power consumption of orchestration components and/or an edge platform, improving hardware utilization to increase management and orchestration efficiency, providing physical and/or end to end security, providing individual tenant quality of service and/or service level agreement satisfaction, improving network equipment-building system compliance level for each use case and tenant business model, pooling acceleration components, and billing and metering policies to improve an edge environment.

A “service” is a broad term often applied to various contexts, but in general, it refers to a relationship between two entities where one entity offers and performs work for the benefit of another. However, the services delivered from one entity to another may be performed with certain guidelines, which ensure trust between the entities and manage the transaction according to the contract terms and conditions set forth at the beginning, during, and end of the service. One type of service that may be offered in an edge environment hierarchy is Silicon Level Services. For instance, Software Defined Silicon (SDSi)-type hardware provides the ability to ensure low level adherence to transactions, through the ability to intra-scale, manage and assure the delivery of operational service level agreements. Use of SDSi and similar hardware controls provide the capability to associate features and resources within a system to a specific tenant and manage the individual title (rights) to those resources. Use of such features is among one way to dynamically “bring” the compute resources to the workload.

For example, an operational level agreement and/or service level agreement could define “transactional throughput” or “timeliness”—in case of SDSi, the system and/or resource can sign up to guarantee specific service level specifications (SLS) and objectives (SLO) of a service level agreement (SLA). For example, SLOs can correspond to particular key performance indicators (KPIs) (e.g., frames per second, floating point operations per second, latency goals, etc.) of an application (e.g., service, workload, etc.) and an SLA can correspond to a platform level agreement to satisfy a particular SLO (e.g., one gigabyte of memory for 10 frames per second). SDSi hardware also provides the ability for the infrastructure and resource owner to empower the silicon component (e.g., components of a composed system that produce metric telemetry) to access and manage (add/remove) product features and freely scale hardware capabilities and utilization up and down. Furthermore, SDSi hardware can provide deterministic feature assignments on a per-tenant basis. In some examples, SDSi hardware also provides the capability to tie deterministic orchestration and service management to the dynamic (or subscription based) activation of features without the need to interrupt running services, client operations or by resetting or rebooting the system.

At a lower layer, SDSi can provide services and guarantees to systems to ensure active adherence to contractually agreed-to service level specifications that a single resource has to provide within the system. Additionally, SDSi provides the ability to manage the contractual rights (title), usage and associated financials of one or more tenants on a per component, or even silicon level feature (e.g., SKU features). Silicon level features may be associated with compute, storage or network capabilities, performance, determinism or even features for security, encryption, acceleration, etc. These capabilities ensure not only that the tenant can achieve a specific service level agreement, but also assist with management and data collection, and assure the transaction and the contractual agreement at the lowest manageable component level.

At a higher layer in the services hierarchy, Resource Level Services, includes systems and/or resources which provide (in complete or through composition) the ability to meet workload demands by either acquiring and enabling system level features via SDSi, or through the composition of individually addressable resources (compute, storage and network). At yet a higher layer of the services hierarchy, Workflow Level Services, is horizontal, since service-chains may have workflow level requirements. Workflows describe dependencies between workloads in order to deliver specific service level objectives and requirements to the end-to-end service. These services may include features and functions like high-availability, redundancy, recovery, fault tolerance or load-leveling (we can include lots more in this). Workflow services define dependencies and relationships between resources and systems, describe requirements on associated networks and storage, as well as describe transaction level requirements and associated contracts in order to assure the end-to-end service. Workflow Level Services are usually measured in Service Level Objectives (SLOs) and have mandatory and expected service requirements.

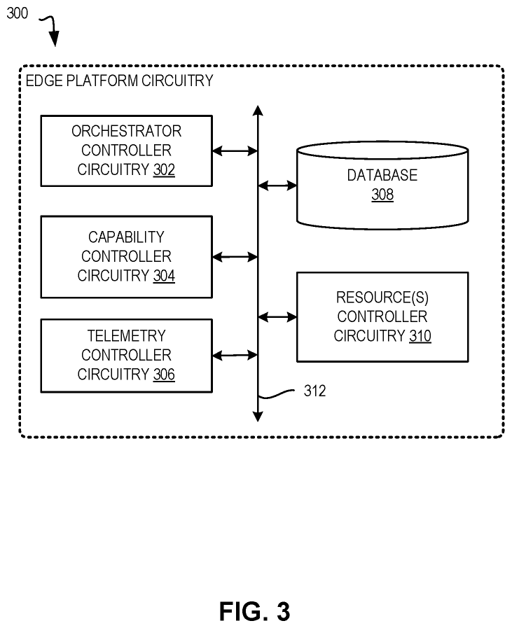

FIG. 3 depicts an example implementation of example edge platform circuitry 300 to process workloads received from client compute nodes. For example, any of the edge gateway platforms 212a, 212b, 212c; the edge aggregation platforms 222a, 222b; and/or the core data center 232 can be implemented by the edge platform circuitry 300. The example edge platform circuitry 300 of FIG. 3 includes example orchestrator controller circuitry 302, example capability controller circuitry 304, example telemetry controller circuitry 306, an example edge platform (EP) database 308, and example resource(s) controller circuitry 310. In the example of FIG. 3, any of the orchestrator controller circuitry 302, the capability controller circuitry 304, the telemetry controller circuitry 306, the EP database 308, and/or the resource(s) controller circuitry 310 may communicate via an example communication bus 312. In examples disclosed herein, the communication bus 312 may be implemented using any suitable wired and/or wireless communication. In additional or alternative examples, the communication bus 312 includes software, machine readable instructions, and/or communication protocols by which information is communicated among the orchestrator controller circuitry 302, the capability controller circuitry 304, the telemetry controller circuitry 306, the EP database 308, and/or the resource(s) controller circuitry 310.

In the example illustrated in FIG. 3, the orchestrator controller circuitry 302, the capability controller circuitry 304, the telemetry controller circuitry 306, the EP database 308, and the resource(s) controller circuitry 310 are included in, correspond to, and/or otherwise is/are representative of the edge platform circuitry 300. However, in some examples, one or more of the orchestrator controller circuitry 302, the capability controller circuitry 304, the telemetry controller circuitry 306, the EP database 308, and the resource(s) controller circuitry 310 can be included in an edge environment including the edge platform circuitry 300 (e.g., the edge cloud 210) rather than be included in the edge platform circuitry 300. For example, the orchestrator controller circuitry 302 can be connected to an endpoint layer (e.g., the endpoint layer 220), an edge device layer (e.g., the edge device layer 230), a network access layer (e.g., the network access layer 240), a core network layer (e.g., the core network layer 250), and/or a cloud data center layer (e.g., the cloud data center layer 260) while being outside of the edge platform circuitry 300.

In other examples, one or more of the orchestrator controller circuitry 302, the capability controller circuitry 304, the telemetry controller circuitry 306, the EP database 308, and the resource(s) controller circuitry 310 is/are separate devices included in an edge environment. Further, one or more of the orchestrator controller circuitry 302, the capability controller circuitry 304, the telemetry controller circuitry 306, the EP database 308, and the resource(s) controller circuitry 310 can be included in an edge device layer (e.g., the edge device layer 330), a network access layer (e.g., the network access layer 340), a core network layer (e.g., the core network layer 350), and/or a cloud data center layer (e.g., the cloud data center layer 360). For example, the orchestrator controller circuitry 302 can be included in an edge devices layer (e.g., the edge devices layer 230), or the resource(s) controller circuitry 310 can be included in a network access layer (e.g., the network access layer 240), a core network layer (e.g., the core network layer 250), and/or a cloud data center layer (e.g., the cloud data center layer 260).

In some examples, in response to a request to execute a workload from a client compute platform (e.g., one of the client compute platforms 202a, 202b, 202c, 202d, 202e, 202f), the orchestrator controller circuitry 302 communicates with at least one of the resource(s) controller circuitry 310 and the client compute platform (e.g., one of the client compute platforms 202a, 202b, 202c, 202d, 202e, 2020 to create a contract (e.g., a workload contract) associated with a description of the workload to be executed. The client compute platform (e.g., one of the client compute platforms 202a, 202b, 202c, 202d, 202e, 2020 provides a task associated with the contract and the description of the workload to the orchestrator controller circuitry 302, and the orchestrator controller circuitry 302 schedules the task to be executed at the edge platform. The task can include the contract and the description of the workload to be executed. In some examples, the task includes requests to acquire and/otherwise allocate resources used to execute the workload.

In some examples, the orchestrator controller circuitry 302 maintains records and/or logs of actions occurring in an endpoint layer (e.g., the endpoint layer 220), an edge device layer (e.g., the edge device layer 230), a network access layer (e.g., the network access layer 240), a core network layer (e.g., the core network layer 250), and/or a cloud data center layer (e.g., the cloud data center layer 260) of an edge environment. For example, the resource(s) controller circuitry 310 can notify receipt of a workload description to the orchestrator controller circuitry 302. The orchestrator controller circuitry 302 and/or the resource(s) controller circuitry 310 provide records of actions and/or allocations of resources to the orchestrator controller circuitry 302. For example, the orchestrator controller circuitry 302 maintains and/or stores a record of receiving a request to execute a workload (e.g., a contract request provided by one of the client compute platforms 202a, 202b, 202c, 202d, 202e, 202f). In some examples, the orchestrator controller circuitry 302 accesses a task and provides and/or assigns the task to one or more of the resource(s) controller circuitry 310 to execute or complete. The resource(s) controller circuitry 310 executes a workload based on a description of the workload included in the task.

In some examples, the orchestrator controller circuitry 302 can be configured to calibrate the power consumption and utilization of the orchestrator controller circuitry 302 (e.g., ones of the resource(s) allocated to the orchestrator 302) and adapt orchestration based on available or predicted power, thermal, and/or resource settings (e.g., budgets). For example, the orchestrator controller circuitry 302 may receive from a client compute platform, with a workload, configuration settings for resource(s) allocated to the orchestrator controller circuitry 302. The orchestrator controller circuitry 302 is configured to adjust a frequency of monitoring and/or scheduling of monitoring data collections, to manage the consumption of resource(s) 310 by the orchestrator controller circuitry 302 (e.g., orchestration components) to comply with SLA objectives while efficiently orchestrating tasks. For example, the orchestrator controller circuitry 302 can adjust the frequency of monitoring telemetry data based on a priority (e.g., priority level) associated with resources at an edge platform (e.g., the edge platform circuitry 300).

In the example of FIG. 3, if the orchestrator controller circuitry 302 receives telemetry data and/or scheduling tasks from a remote device, the orchestrator controller circuitry 302 may, in general, be very lightweight in power consumption and produce simpler forms of telemetry extraction or orchestration guidance when processing telemetry data and/or scheduling tasks. Additionally, the orchestrator controller circuitry 302 may be in more stable power environments as compared to the remote device that transmitted telemetry data and/or scheduling tasks to the remote device. For example, the remote device could be an edge platform in the same layer of an edge environment as the edge platform circuitry 300 that is at a lower power level than the edge platform circuitry 300. In additional or alternative examples, the remote device could be an edge platform in a layer of an edge environment that is geographically closer to a client compute platform than the edge platform circuitry 300.

In the illustrated example of FIG. 3, the capability controller circuitry 304 determines the capabilities of the edge platform circuitry 300 during registration and onboarding of the edge platform circuitry 300. For example, the capability controller circuitry 304 generates capability data (e.g., hardware resources, storage resources, network resources, software resources, etc. at the edge platform 200). For example, the capability controller circuitry 304 can determine the resource(s) allocated to the edge platform circuitry 300, such as, hardware resources (e.g., compute, network, security, storage, etc., hardware resources), software resources (e.g., a firewall, a load balancer, a virtual machine (VM), a guest operating system (OS), an application, a hypervisor, etc.), etc., and/or a combination thereof, based on the capability data, from which edge computing workloads (e.g., registered workloads) can be executed. In some examples, the capability controller circuitry 304 can determine containers provisioned and/or executing at the edge platform circuitry 300. For example, the capability controller circuitry 304 can identify micro-services associated with containers provisioned at the edge platform circuitry 300 and/or resources allocated to containers at the edge platform circuitry 300.

In some examples, the capability controller circuitry 304 retrieves the capability data from the EP database 308. For example, when the orchestrator controller circuitry 302 receives a request to execute a workload, the orchestrator controller circuitry 302 identifies, by accessing the capabilities controller circuitry 304 and/or the EP database 308, whether the capabilities of the edge platform circuitry 300 includes proper resource(s) to fulfill the workload task. For example, if the orchestrator controller circuitry 302 receives a request to execute a workload that requires a processor with two cores, the orchestrator controller circuitry 302 can access the capabilities controller circuitry 304 and/or the EP database 308 to determine whether the edge platform circuitry 300 includes the capability to process the requested workload.

In the example of FIG. 3, the capability controller circuitry 304 additionally determines the capabilities of new and/or additional resources allocated to the edge platform circuitry 300. For example, if the edge platform circuitry 300 is upgraded by an edge service provider to include additional computational resources, storage resources, and/or network resources, the capabilities controller circuitry 304 can register the additional resources and generate capability data associated with the additional resources. In some examples, the capability controller circuitry 304 can generate and/or transmit protocols to interface with resources (e.g., the resource(s) 310) at the edge platform circuitry 300 to one or more of the orchestrator controller circuitry 302, the telemetry controller circuitry 306, and/or the EP database 308.

In the illustrated example of FIG. 3, the telemetry controller circuitry 306 improves the distribution and execution of edge computing workloads (e.g., among edge platforms) based on telemetry data associated with edge platforms in an edge computing environment. For example, the telemetry controller circuitry 306 can determine that a first edge platform and/or a second edge platform has available one(s) of the resource(s), such as hardware resources (e.g., compute, network, security, storage (e.g., non-volatile memory express), etc., hardware resources), software resources (e.g., a firewall, a load balancer, a virtual machine (VM), a guest operating system (OS), an application, a hypervisor, etc.), etc., and/or a combination thereof, based on telemetry data, from which edge computing workloads can be executed. In such examples, the telemetry data can include a utilization (e.g., a percentage of a resource that is utilized or not utilized), a delay (e.g., an average delay) in receiving a service (e.g., latency), a rate (e.g., an average rate) at which a resource is available (e.g., bandwidth, throughput, etc.), power expenditure, temperatures, etc., associated with one(s) of the resource(s) of at least one of edge platform (e.g., the edge platform circuitry 300 and/or an alternative edge platform).

In the illustrated example of FIG. 3, the edge platform circuitry 300 includes the EP database 308 to record data (e.g., telemetry data, workloads, capability data, etc.). The EP database 308 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The EP database 308 can additionally or alternatively be implemented by double data rate (DDR) memories, such as DDR, DDR2, DDR3, DDR4, mobile DDR (mDDR), etc. The EP database 308 can additionally or alternatively be implemented by one or more mass storage devices such as hard disk drive(s), compact disk drive(s), digital versatile disk drive(s), solid-state disk drive(s), etc. While in the illustrated example the EP database 308 is illustrated as a single database, the EP database 308 can be implemented by any number and/or type(s) of databases. Furthermore, the data stored in the EP database 308 can be in any data format such as, for example, binary data, comma delimited data, tab delimited data, structured query language (SQL) structures, etc.

In the illustrated example of FIG. 3, the resource(s) controller circuitry 310 executes a workload (e.g., an edge computing workload) obtained from a client compute platform. For example, the resource(s) controller circuitry 310 determines resource(s) that can correspond to and/or otherwise be representative of an edge platform or portion(s) thereof. For example, the orchestrator controller circuitry 302, the capability controller circuitry 304, the telemetry controller circuitry 306, the EP database 308, and/or, more generally, the edge platform circuitry 300 can invoke a respective one of the resource(s) identified by the resource(s) controller circuitry 310 to execute one or more edge-computing workloads. In some examples, the resource(s) are representative of hardware resources, virtualizations of the hardware resources, software resources, virtualizations of the software resources, etc., and/or a combination thereof. For example, the resource(s) controller circuitry 310 can identify resource(s) that can include, correspond to, and/or otherwise be representative of one or more CPUs (e.g., multi-core CPUs), one or more FPGAs, one or more GPUs, one or more network interface cards (NICs), one or more vision processing units (VPUs), etc., and/or any other type of hardware or hardware accelerator. In such examples, the resource(s) can include, correspond to, and/or otherwise be representative of virtualization(s) of the one or more CPUs, the one or more FPGAs, the one or more GPUs, the one more NICs, etc. In other examples, the orchestrator controller circuitry 302, the capability controller circuitry 304, the telemetry controller circuitry 306, the EP database 308, the resource(s) controller circuitry 310, and/or, more generally, the edge platform circuitry 300, can include, correspond to, and/or otherwise be representative of one or more software resources, virtualizations of the software resources, etc., such as hypervisors, load balancers, OSes, VMs, etc., and/or a combination thereof.

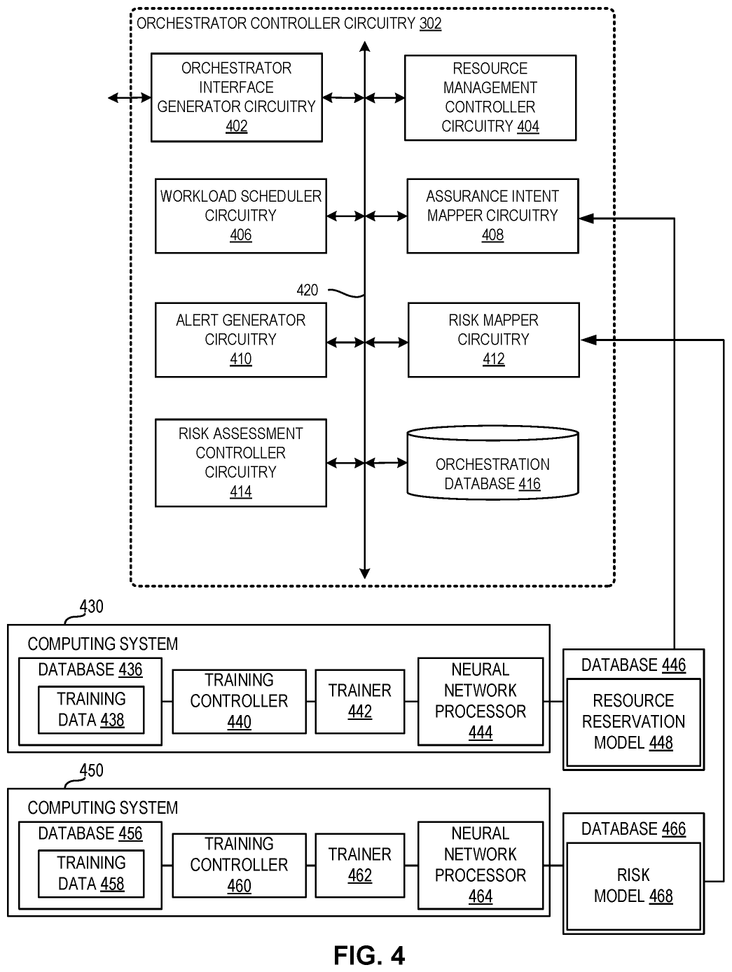

FIG. 4 is a block diagram of an example implementation of the orchestrator controller circuitry 302 of FIG. 3. The orchestrator controller circuitry 302 of FIG. 3 may be instantiated (e.g., creating an instance of, bring into being for any length of time, materialize, implement, etc.) by programmable circuitry such as a Central Processing Unit (CPU) executing first instructions. Additionally or alternatively, the orchestrator controller circuitry 302 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the example of FIG. 4, the orchestrator controller circuitry 302 includes example orchestrator interface generator circuitry 402, example resource management controller circuitry 404, example workload scheduler circuitry 406, example assurance intent mapper circuitry 408, example alert generator circuitry 410, example risk mapper circuitry 412, example risk assessment controller circuitry 414, and an example orchestration database 416. In the example of FIG. 4, any of the orchestrator interface generator circuitry 402, the resource management controller circuitry 404, the workload scheduler circuitry 406, the assurance intent mapper circuitry 408, the alert generator circuitry 410, the risk mapper circuitry 412, the risk assessment controller circuitry 414, and the orchestration database 416 may communicate via an example communication bus 420. In examples disclosed herein, the communication bus 420 may be implemented using any suitable wired and/or wireless communication. In additional or alternative examples, the communication bus 420 includes software, machine readable instructions, and/or communication protocols by which information is communicated among the orchestrator interface generator circuitry 402, the resource management controller circuitry 404, the workload scheduler circuitry 406, the assurance intent mapper circuitry 408, the alert generator circuitry 410, the risk mapper circuitry 412, the risk assessment controller circuitry 414, and/or the orchestration database 416.

The orchestrator interface generator circuitry 402 controls communication (e.g., communications related to orchestration) with the edge platform circuitry 300 and/or remote edge platforms (e.g., near-edge platforms with respect to the edge platform circuitry 300, a next-tier, etc.). The orchestrator interface generator circuitry 402 is configured to determine whether the edge platform circuitry 300 has received telemetry data from a remote edge platform. For example, the orchestrator interface generator circuitry 402, and/or more generally, the orchestrator controller circuitry 302, can receive telemetry data from an edge platform that is geographically closer to a client compute platform than the edge platform circuitry 300. In response to determining that the edge platform 200 has received telemetry data from a remote edge platform, the orchestrator interface generator circuitry 402 transmits the telemetry data and/or any additional data (e.g., indication of granularity, configuration settings for remote edge platform orchestrator, etc.) to the resource management controller circuitry 404.

The resource management controller circuitry 404 is configured to manage resource consumption of resource(s) by orchestration components (e.g., the orchestration interface generator circuitry 402, the resource management controller circuitry 404, the workload scheduler circuitry 406) and/or other components of the edge platform circuitry 300 (e.g., the capability controller circuitry 304, the telemetry controller circuitry 306, the EP database 308 and/or the resource(s) controller circuitry 310). For example, the resource management controller circuitry 404 monitors the utilization of power and/or various other resources by orchestration components and/or other components of an edge platform. Depending on the amount of resources that is available at the edge platform, and the estimated or pledged amount of each to the workloads executing at the edge platform, the resource management controller circuitry 404 may raise, lower, or transfer the work for telemetry and orchestration to a next near-edge tier.

To manage the resources at an edge platform (e.g., the edge platform circuitry 300), the resource management controller circuitry 404 requests, from an orchestrator at a remote edge platform and/or another computer, the orchestration results. Additionally or alternatively, the resource management controller circuitry 404 can manage resources at an edge platform based on KPIs associated with an application (e.g., a workload, service, etc.). In some examples, the resource management controller circuitry 404 and/or the orchestrator controller circuitry 302 can adjust resource allocation at the edge platform to meet given SLOs of an SLA for each service and/or workload executing at the edge platform. Additionally or alternatively, the resource management controller circuitry 404 estimates, based on the telemetry data collected by the orchestrator interface generator circuitry 402, the amount of resources to be utilized by various services, applications, and/or workloads assigned to the edge platform to meet the respective SLAs associated with each of the services, applications, and/or workloads. Based on the amount of services estimated to be utilized, the resource management controller circuitry 404 determines what quantity of resources may be released from, or made available to, the orchestration components at the edge platform.

The workload scheduler circuitry 406 generally schedules one or more workloads, services, and/or applications to execute at an edge platform. In some examples, scheduling includes accessing a task received and/or otherwise obtained by the resource management controller circuitry 404 and provide the task to one or more of the resources at an edge platform to execute or complete. In some examples, scheduling includes selecting ones of workloads assigned to an edge platform to offload to a remote edge platform to be executed. The workload scheduler circuitry 406 accesses a result of the execution of the workload from one or more of the resources at the edge platform that executed the workload. The workload scheduler circuitry 406 provides the result to the device that requested the workload to be executed, such as a client compute platform and/or other edge platform. In some examples, the workload scheduler circuitry 406 is configured to determine whether a candidate schedule satisfies one or more SLAs associated with one or more workloads.

The assurance intent mapper circuitry 408 maps assurance intents and evaluates intent-based assurance effectiveness. For example, an assurance intent refers to a cluster level assurance focusing on policies such as a percentage of nodes in a cluster with a certain level, coverage of the orchestration control plane, high-availability (HA) deployment, etc. For example, a cluster level assurance intent represents a resource availability criterion to meet a target availability of the resource. A cluster (e.g., Kubernetes cluster) represents a set of nodes that run containerized applications. In some examples, the cluster is a set of servers that are managed together and participate in workload management. The assurance intent mapper circuitry 408 maps assurance intents to service orchestration and resource orchestration (e.g., reservation of resources for on-demand dynamic service assurance probes). In examples disclosed herein, a probe can be used for monitoring and gathering of information about events affecting containers and/or validating the health of workloads (e.g., applications running on Kubernetes). In some examples, probes can be used to collect telemetry information (e.g., Kubernetes probes allow validating the state of pods running within a cluster, while the workloads run within the pods). For example, once appropriate passive monitoring and analytics stacks are selected and deployed, the assurance intent mapper circuitry 408 reserves compute resources. In some examples, the assurance intent mapper circuitry 408 reserves a single dedicated server (e.g., as part of an edge deployment or reserve core(s) on a 5G core server) for the co-deployment of an active probe on demand (e.g., at some point in the future). In some examples, the assurance intent mapper circuitry 408 reserves memory bandwidth, cache, Structural Simulation Toolkit (SST) cores, and/or interface bandwidth for the active probe. In some examples, the assurance intent mapper circuitry 408 tracks active probes using artificial intelligence-based tracking to monitor active probe(s) and based on core availability provides the cores that are available and have the desired capabilities (e.g., 5G capable, etc.). In some examples, the assurance intent mapper circuitry 408 performs forced reservation for active probes to prioritize deploying the active probe by forcefully freeing up capacity. For example, the assurance intent mapper circuitry 408 performs forced reservation using a combination of forced scaling down of deployed workload capacity (e.g., apart from the workload under testing), temporarily evicts other workloads, and/or adds capacity to the workload under test to deploy the active probe with a sidecar pattern (e.g., a single node pattern including an application container and a sidecar container). In some examples, the assurance intent mapper circuitry 408 uses policy governance to determine whether a permanent reserve or a forceful deploy pattern can be used for reservation of active probes. In some examples, the assurance intent mapper circuitry 408 uses a supervised tree-based machine learning model to determine when to perform freeing and/or scaling down of deployed workload capacity. However, any other type of machine learning model can be implemented for determining the type of forced reservation to perform. In some examples, the assurance intent mapper circuitry 408 uses a dataset for a given policy to assist in the freeing or scaling down of the deployed workload. As such, when the orchestrator controller circuitry 302 determines that reservation of resources is needed (e.g., via input from a monitoring and analytics stack), the orchestrator controller circuitry 302 deploys active probes to the compute resources reserved for the active probe using the assurance intent mapper circuitry 408.

In examples disclosed herein, assurance domain polices include K8S deployment in high availability configurations, high availability K8S ingress load balancer configurations (e.g., external to K8S), enablement of storage availability resiliency schemes (RAID X, etc.), storage monitoring and analytics enablement, K8S auditing and tracing enablement, SDN/NMS availability policies (1:1 redundant switch, etc.), service mesh monitoring and analytics enablement (e.g., Cilium), network interface HA schemes (e.g., port redundancy, multi-path) enablement, IPU monitoring enablement, port flow telemetry enablement, open telemetry gateways enablement, etc. In some examples, automated assurance check policies include infra telemetry collectors deployment, infra telemetry collectors reachability, monitoring system deployment and reachability, analytics deployment and reachability, reserved space for active probes availability, K8S cluster accessibility, cluster telemetry (e.g., Kubernetes state metrics) API accessibility, monitoring and analytics system infra health, network management station (NMS)/software defined networking (SDN) system reachability and activity, open telemetry gateways activity and reachability, etc. In some examples, validation and periodic verifying that various software and hardware aspects of the system are within acceptable ranges is performed and/or excursions are predicted. In examples disclosed herein, cluster level assurance policies include percentages of nodes in a cluster with a certain level, coverage of the orchestration control plane, high-availability (HA) deployment, storage resiliency models, extraction of assurance capabilities/wellness from the underlying Infrastructure as a Service (IaaS) layer, assessment of active/passive assurance capabilities (e.g., with possibility of associating charging with capability), and/or cluster audit capability availability.

In examples disclosed herein, infrastructure network equipment to implement the assurance domain polices, automated assurance check policies, and/or cluster level assurance policies can vary. For example, various architectures (e.g., Intel® Tofino, Infrastructure Processing Units (IPUs), etc.) can be used to establish distributed/delegate monitoring, followed by more centralized and coordinated measurement entities (e.g., switches). A type of network of virtual channels or network flows can be defined to perform this aspect, with separation from remaining traffic and management by K8S (e.g., exposing capabilities to execute K8S plugins that are specific for a switch). In some examples, switches can include methods to register rules that identify situations that should not happen at the same time and that can be identified by monitoring of multiple KPIs from various platforms/resources/services. In some examples, switches can require the IPUs connecting a particular platform to monitor certain resources or services and trigger back an alarm (e.g., using alert generator circuitry 410) whenever a particular monitoring condition occurs (e.g., service not responding or resource not working properly). In some examples, switches receiving events relate them to a specific rule and on rule assertion may trigger notification to the orchestrator controller circuitry 302.

As illustrated in FIG. 4, the assurance intent mapper circuitry 408 is in communication with a first example computing system 430 that trains a neural network to generate an example resource reservation model 448. For example, as described above, the assurance intent mapper circuitry 408 can use supervised tree-based machine learning model(s) to determine when to perform freeing and/or scaling down of deployed workload capacity. In examples disclosed herein, any training algorithm may be used. In examples disclosed herein, training can be performed based on early stopping principles in which training continues until the model(s) stop improving. In examples disclosed herein, training can be performed remotely or locally. In some examples, training may initially be performed remotely. Further training (e.g., retraining) may be performed locally based on data generated as a result of execution of the models. Training is performed using hyperparameters that control how the learning is performed (e.g., a learning rate, a number of layers to be used in the machine learning model, etc.). In examples disclosed herein, hyperparameters that control complexity of the model(s), performance, duration, and/or training procedure(s) can be used. Such hyperparameters are selected by, for example, random searching and/or prior knowledge. In some examples re-training may be performed. Such re-training may be performed in response to new input datasets, drift in the model performance, and/or updates to model criteria and system specifications.

Training is performed using training data. In examples disclosed herein, the training data originates from previous freeing up or scaling down of deployed workload capacity to determine which resource reservation approach is effective for a given task (e.g., based on whether a permanent reserve or a forceful deploy pattern can be used for reservation of active probes). In some examples, the training data is labeled. In some examples, the training data is sub-divided such that a portion of the data is used for validation purposes.

Once training is complete, the resource reservation model(s) are stored in one or more databases (e.g., the database 446 of FIG. 4). One or more of the models may then be executed by, for example, the assurance intent mapper circuitry 408. Once trained, the deployed model(s) may be operated in an inference phase to process data. In the inference phase, data to be analyzed (e.g., live data) is input to the model, and the model executes to create an output. This inference phase can be thought of as the artificial intelligence (AI) “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 4, the first computing system 430 trains a neural network to generate the resource reservation model 448. The example first computing system 430 includes an example neural network processor 444. In examples disclosed herein, the neural network processor 444 implements a neural network. The first computing system 430 of FIG. 4 also includes an example neural network trainer 442. The neural network trainer 442 of FIG. 4 performs training of the neural network implemented by the neural network processor 444.

The first computing system 430 of FIG. 4 includes an example training controller 440. The training controller 440 instructs the neural network trainer 442 to perform training of the neural network based on example training data 438. In the example of FIG. 4, the training data 438 used by the neural network trainer 442 to train the neural network is stored in an example database 436. The example database 436 of the illustrated example of FIG. 4 is implemented by any memory, storage device and/or storage disc for storing data such as, for example, flash memory, magnetic media, optical media, etc. Furthermore, the data stored in the example database 436 may be in any data format such as, for example, binary data, comma delimited data, tab delimited data, structured query language (SQL) structures, image data, etc. While the illustrated example database 436 is illustrated as a single element, the database 436 and/or any other data storage elements described herein may be implemented by any number and/or type(s) of memories. The neural network trainer 442 trains the neural network implemented by the neural network processor 444 using the training data 438 to generate the resource reservation model 448 as a result of the neural network training. The resource reservation model 448 is stored in a database 446. The databases 436, 446 may be the same storage device or different storage devices.

The alert generator circuitry 410 generates an alert when an assurance intent is not met. In some examples, the alert generator circuitry 414 performs a series of automated checks, based on a predefined policy, which defines the target (e.g., required, specified, etc.) assurance capabilities. In some examples, the target assurance capabilities include the following: (1) platform collectors deployed and active, (2) platform collector reachable, (3) monitoring system deployed, (4) monitoring system accessible, (5) reserved space for active probes available, (6) K8S cluster accessible, (7) K8S ingress load balancer available, (8) Kube-stats service available and reachable, (9) Monitoring & analytics system platform fault count within tolerance, and/or (10) SDN system available. In some examples, the alert generator circuitry 414 performs automated checks using artificial intelligence (e.g., using a supervised model). In some examples, the alert generator circuitry 414 calculates an overall score indicating the number of intents met. Based on the calculated score, the alert generator circuitry 414 generates an alert when a threshold number of intents is not reached (e.g., as compared to intents expressed for assurance by a service owner or resource owner). In some examples, the alert generator circuitry 414 identifies test results from cluster deployment health metrics.

The risk mapper circuitry 412 maps a risk intent to deployment methods and mitigations. In examples disclosed herein, risk mitigations generation includes expressing the risk as a probability of occurrence and impact, expressed as a cost value, with impact to end users and the cost to repair used as inputs. In some examples, the risk mapper circuitry 412 builds models of risks overtime, based on observed risk occurrence, impact and meantime to repair, and produces a model for each layer of a stack. Risk models are produced for faults in the orchestration layer, infrastructure layer, service orchestration layer, monitor and analytics layer, etc. In some examples, the service to be deployed provides an intent-based risk tolerance profile/descriptor, that can include allowable outage time, time to repair, cost to repair, allowable number of users to be impacted, degradation allowable on app specific SLOs. In some examples, the risk mapper circuitry 412 considers the risk profile and distributes risk to each layer of the stack and to specific resources. For example, the risk mapper circuitry 412 matches highly reliable resources to risk intents that have the largest impact on cost and the lowest tolerance to outage time. In some examples, the risk mapper circuitry 412 monitors and evaluates the effectiveness of mitigations over time.

In some examples, the risk mapper circuitry 412 collects data on faults and numbers of interactions that are impacted by faults so that divergence of actual risk (e.g., as measured by a cost function of impacts) from projected risk can be used in retraining the risk assessments and for focusing postmortem analyses and adapting escalations, allowing generated risk models to be continually updated over time. For example, risk hierarchy and risk relationships can be built into the models supporting an up-leveling of risk from lower layers of the stack to higher layers, allowing for an impact to be associated with certain risks. In examples disclosed herein, risk mitigations (e.g., as part of the risk model) can be expressed as desired intents (e.g., mitigate high impact risks using automatic remediations and notify human operators when remediations do not work, etc.). In some examples, mitigations can include adding more capacity on failure conditions, 1+N protection switching, 1:1 protection schemes, path rerouting to alternate sites, etc. In some examples, risk model updates can be part of an attestation architecture, allowing the trust to not only be established but also validated. In some examples, extended telemetry can be used to assess whether certain mitigations are helpful and to what extent, since mitigations may take some time to work and may produce temporary but acceptable setbacks (e.g., more latency, less throughput) before improvements are achieved.

In examples disclosed herein, the risk mapper circuitry 412 receives an intent based risk tolerance profile. For example, the service to be deployed provides an intent-based risk tolerance profile, that includes allowable outage time, time to repair, cost to repair, allowable number of users to be impacted, etc. In some examples, the information includes regulatory risks for availability of services (e.g., associated with the Federal Communications Commission (FCC)) and/or reliability risks from analytics. The risk mapper circuitry 412 performs risk intent mapping by mapping the received allowable risk to a probability of occurrence in each domain (e.g., infra, software, switching, cluster, Kubernetes, etc.) expressed as a service risk profile. In some examples, the service risk profile is the probability of occurrence in each domain and impact, expressed as a cost (e.g., dollar value), impact to end users, and/or cost to repair as inputs. The risk mapper circuitry 412 generates domain specific risk mitigations by assessing the service risk profile and producing risk mitigations for each risk domain. In some examples, the risk mapper circuitry 412 uses a reliability modeling component to build models of risks overtime, based on observed risk occurrence, impact and meantime to repair, and produces a model for each layer of the stack. Risk models are produced for faults in the orchestration layer, infrastructure layer, service orchestration layer, monitor and analytics layer.

In some examples, risk mitigations include selecting resources using reliability ranges and reliability features (e.g., CPU reliability within acceptable range, memory reliability within acceptable range, etc.). Select platforms can include CPU reliability, availability, serviceability (RAS) features/memory RAS features/QAT RAS, IPU RAS, K8 cluster reliability features, high availability deployment configurations, multi-homed networking capabilities, etc. In examples disclosed herein, reliability functions can include functions such as SDN controllers for multi-pathing and/or load balancing for service resiliency. In some examples, the risk mapper circuitry 412 sends a trigger to the resource orchestrator to rebalance/reprovision workloads to operate around the identified sources of risk (e.g., under the governance of the hierarchical risk model).

As illustrated in FIG. 4, the risk mapper circuitry 412 is in communication with a second example computing system 450 that trains a neural network to generate an example risk model 468. For example, as described above, the risk mapper circuitry 412 generates model(s) of risks based on observed risk occurrence, impact and meantime to repair, and produces a model for faults in the orchestration layer, infrastructure layer, service orchestration layer, monitor and analytics layer, etc. In examples disclosed herein, the training data used for training during model generation originates from observed risk occurrence, impact and meantime to repair. As previously described, risk models are produced for faults in the orchestration layer, infrastructure layer, service orchestration layer, monitor and analytics layer, etc. In some examples, the training data is labeled. In some examples, the training data is sub-divided such that a portion of the data is used for validation purposes.

Once training is complete, the risk model(s) are stored in one or more databases (e.g., the database 466 of FIG. 4). One or more of the models may then be executed by, for example, the risk mapper circuitry 412. Once trained, the deployed model(s) may be operated in an inference phase to process data. In the inference phase, data to be analyzed (e.g., live data) is input to the model, and the model executes to create an output. Moreover, in some examples, the output data may undergo post-processing after it is generated by the AI model to transform the output into a useful result (e.g., a display of data, an instruction to be executed by a machine, etc.). In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 4, the second computing system 450 trains a neural network to generate the risk model 468. The example second computing system 450 includes an example neural network processor 464. In examples disclosed herein, the neural network processor 464 implements a neural network. The second computing system 450 of FIG. 4 also includes an example neural network trainer 462. The neural network trainer 462 of FIG. 4 performs training of the neural network implemented by the neural network processor 464.

The second computing system 450 of FIG. 4 includes an example training controller 460. The training controller 460 instructs the neural network trainer 462 to perform training of the neural network based on example training data 458. In the example of FIG. 4, the training data 458 used by the neural network trainer 462 to train the neural network is stored in an example database 456. The example database 456 of the illustrated example of FIG. 4 is implemented by any memory, storage device and/or storage disc for storing data such as, for example, flash memory, magnetic media, optical media, etc. Furthermore, the data stored in the example database 456 may be in any data format such as, for example, binary data, comma delimited data, tab delimited data, structured query language (SQL) structures, image data, etc. While the illustrated example database 456 is illustrated as a single element, the database 456 and/or any other data storage elements described herein may be implemented by any number and/or type(s) of memories. The neural network trainer 462 trains the neural network implemented by the neural network processor 464 using the training data 458 to generate the risk model 468 as a result of the neural network training. The risk model 468 is stored in a database 466. The databases 456, 466 may be the same storage device or different storage devices.

The risk assessment controller circuitry 414 performs risk assessment at a local level or at a cluster level. For example, the risk assessment controller circuitry 414 performs risk assessment at a local level by analyzing performance metrics and generating real time alerts when risk mitigations are removed and/or a platform is misconfigured. The risk assessment controller circuitry 414 generates alerts when platform risk such as reliability change occurs and/or triggers real-time risk mitigations after the risk has occurred. In examples disclosed herein, the risk assessment controller circuitry 414 additionally or alternatively analyzes cluster metrics and generates real-time alerts when cluster level risk mitigations are removed or misconfigured. The risk assessment controller circuitry 414 generates alerts when the cluster cannot support a risk such as reliability change and triggers real-time risk mitigations after the risk has occurred for inter-cluster scheduling. In examples disclosed herein, reputation attestation accounts for resources risks that can evolve over time and may have different perspectives or experiences depending on who is using the resource itself. Services that are responsible to establish the risk can be part of an attestation architecture as follows: (1) the assessment these services provide can be tracked in blockchain to be traceable over time and attested and (2) the reputation for those services to provide a real assessment can be monitored. For example, given that service A provides high risk assessment based on the execution on resource B at a specific timestamp (e.g., 20 seconds and afterwards), executing multiple services A using resource B can be determined to provide low risk. Over time, the reputation of service A can be established as well.

In examples disclosed herein, hardware support for risk mitigation accounts for the platform having various resources that can have different risk mitigation software defined silicon (SDSi)-based configurations. In some examples, the risk mapper circuitry 412 maps different properties of the platform and identifies node architecture that may provide different features that could be used to mitigate risk. For example, a sub-NUMA cluster (SNC) to create independent compute domains within a CPU could allow for use of different types of interleaving to have different domains-based memory corruption, and a Compute Express Link (CXL) could be used to isolate different elements of the architecture. For example, each of these aspects has implications that need to be handled and matched with respect to the application or service key performance indicators (KPIs) when implementing risk mitigation. Furthermore, hardware support for risk variance can be performed such that the platform can reassess risk over time (e.g., on detection of changing error counts or frequencies such as from memory, I/O, or networking, etc.) to modify the perceived risk of the platform.

The orchestration database 416 stores telemetry data, workloads, models, schedules, SLAs, SLOs, KPIs, etc. The orchestration database 416 can be used to store any information associated with the orchestrator interface generator circuitry 402, resource management controller circuitry 404, workload scheduler circuitry 406, assurance intent mapper circuitry 408, alert generator circuitry 410, risk mapper circuitry 412, and/or risk assessment controller circuitry 414. The orchestration database 416 of the illustrated example of FIG. 4 can be implemented by any memory, storage device and/or storage disc for storing data such as flash memory, magnetic media, optical media, etc. Furthermore, the data stored in the example orchestration database 416 can be in any data format such as binary data, comma delimited data, tab delimited data, structured query language (SQL) structures, image data, etc.

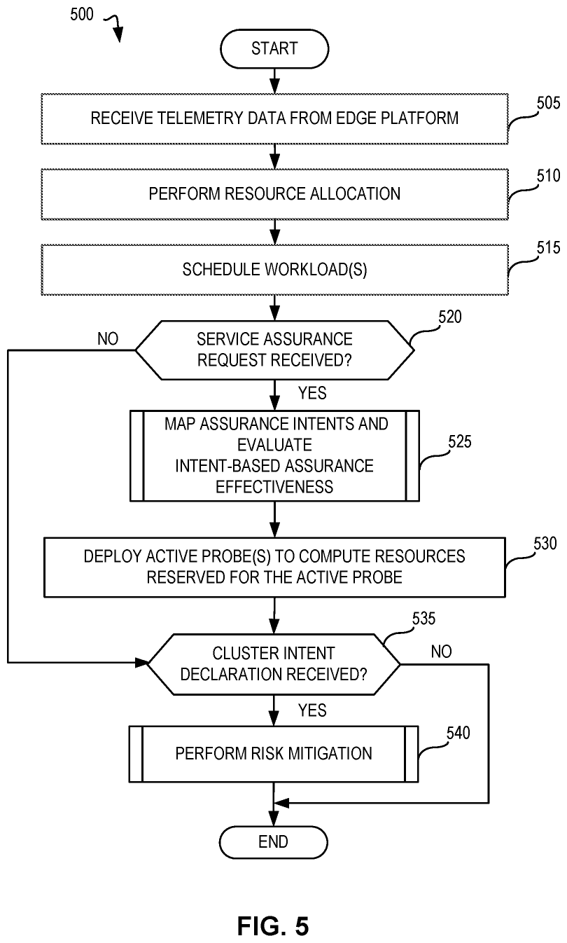

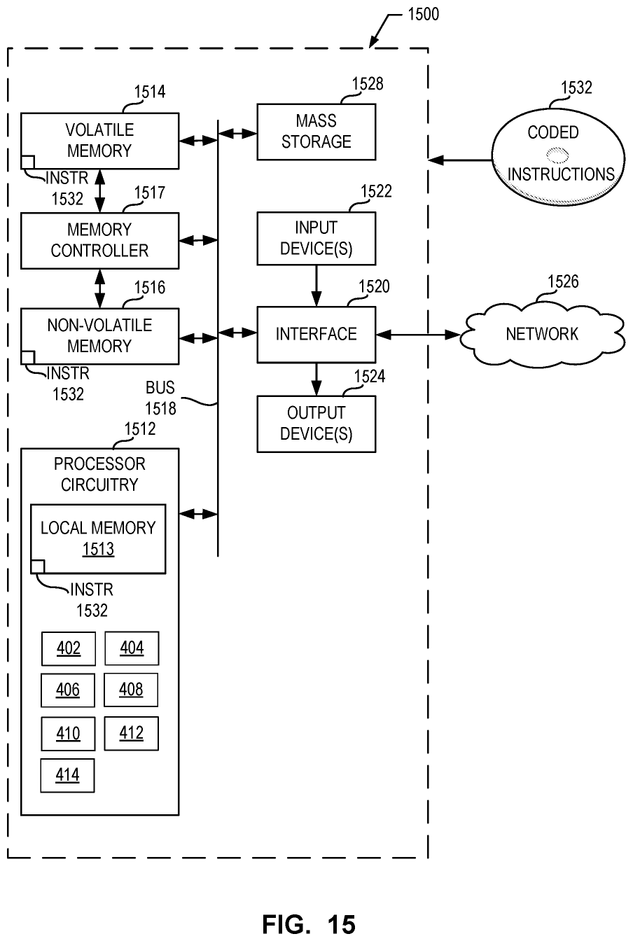

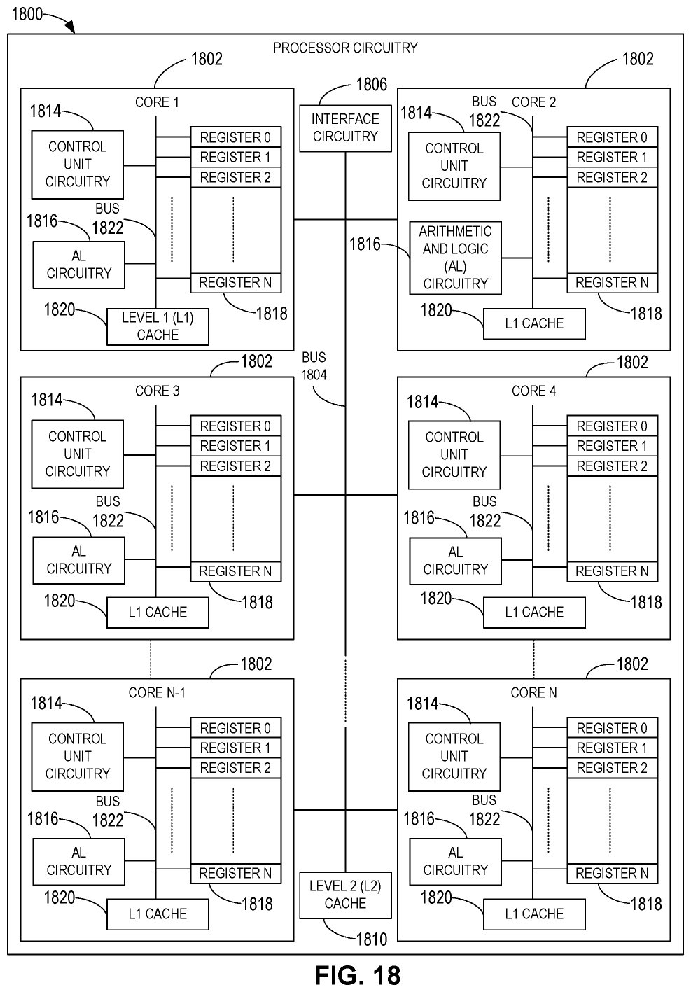

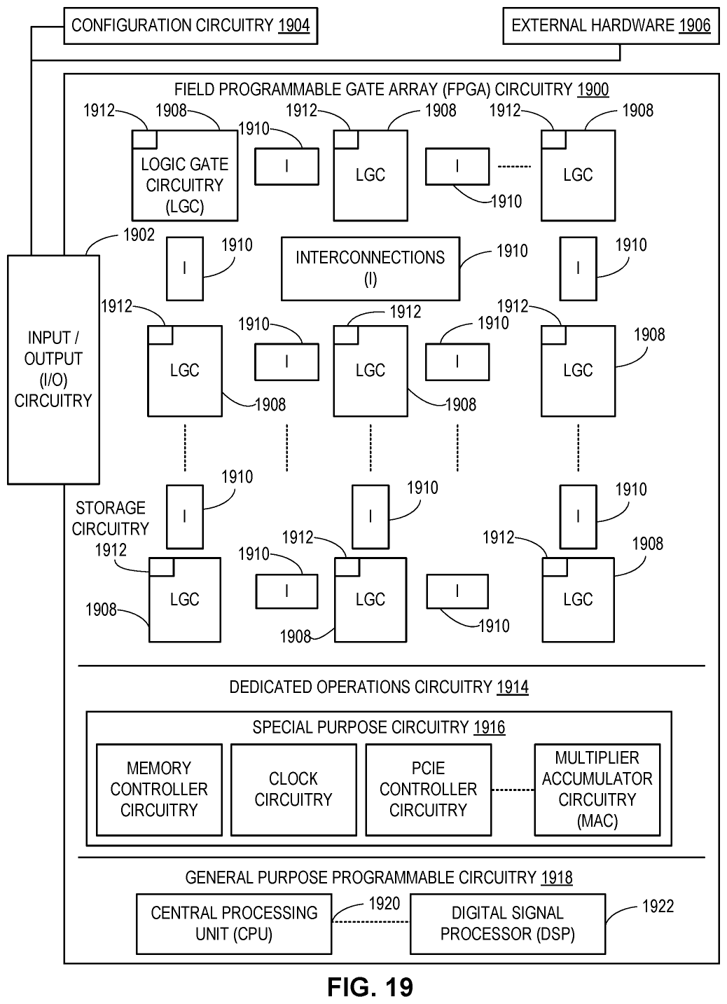

In some examples, the apparatus includes means for generating an orchestrator interface. For example, the means for generating an orchestrator interface may be implemented by orchestrator interface generator circuitry 402. In some examples, the orchestrator interface generator circuitry 402 may be instantiated by programmable circuitry such as the example programmable circuitry 1512 of FIG. 15. For instance, the orchestrator interface generator circuitry 402 may be instantiated by the example microprocessor 1800 of FIG. 18 executing machine executable instructions such as those implemented by at least block 505 of FIG. 5. In some examples, the orchestrator interface generator circuitry 402 may be instantiated by hardware logic circuitry, which may be implemented by an ASIC, XPU, or the FPGA circuitry 1900 of FIG. 19 structured to perform operations corresponding to the machine readable instructions. Additionally or alternatively, the orchestrator interface generator circuitry 402 may be instantiated by any other combination of hardware, software, and/or firmware. For example, the orchestrator interface generator circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for resource management. For example, the means for resource management may be implemented by resource management controller circuitry 404. In some examples, the resource management controller circuitry 404 may be instantiated by programmable circuitry such as the example programmable circuitry 1512 of FIG. 15. For instance, the resource management controller circuitry 404 may be instantiated by the example microprocessor 1800 of FIG. 18 executing machine executable instructions such as those implemented by at least block 510 of FIG. 5. In some examples, the resource management controller circuitry 404 may be instantiated by hardware logic circuitry, which may be implemented by an ASIC, XPU, or the FPGA circuitry 1900 of FIG. 19 structured to perform operations corresponding to the machine readable instructions. Additionally or alternatively, the resource management controller circuitry 404 may be instantiated by any other combination of hardware, software, and/or firmware. For example, the resource management controller circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for scheduling a workload. For example, the means for scheduling a workload may be implemented by workload scheduler circuitry 406. In some examples, the workload scheduler circuitry 406 may be instantiated by programmable circuitry such as the example programmable circuitry 1512 of FIG. 15. For instance, the workload scheduler circuitry 406 may be instantiated by the example microprocessor 1800 of FIG. 18 executing machine executable instructions such as those implemented by at least block 515 of FIG. 5. In some examples, the workload scheduler circuitry 406 may be instantiated by hardware logic circuitry, which may be implemented by an ASIC, XPU, or the FPGA circuitry 1900 of FIG. 19 structured to perform operations corresponding to the machine readable instructions. Additionally or alternatively, the workload scheduler circuitry 406 may be instantiated by any other combination of hardware, software, and/or firmware. For example, the workload scheduler circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

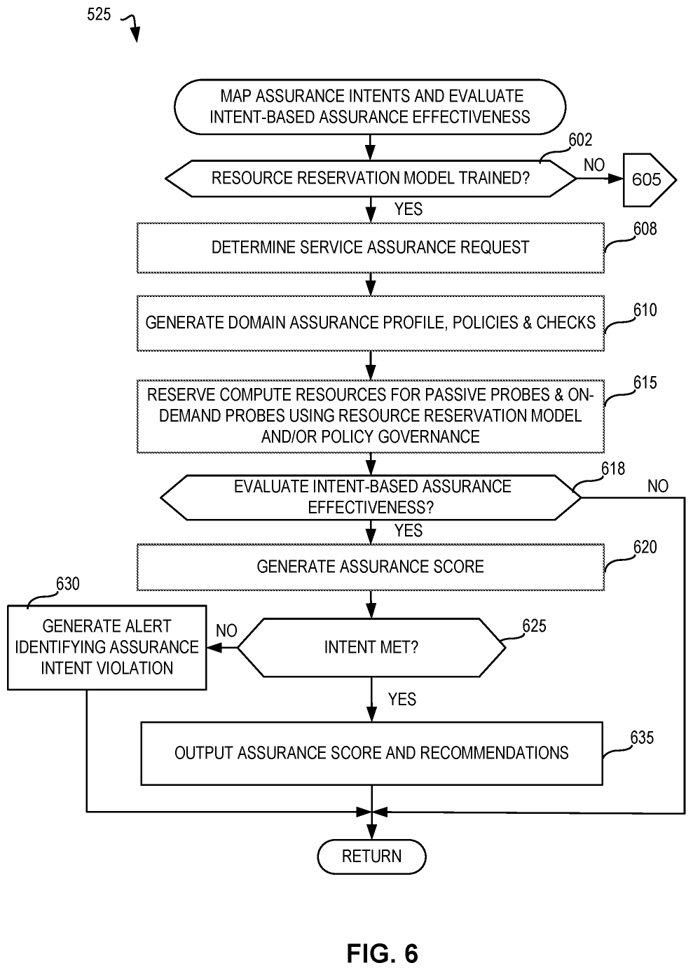

In some examples, the apparatus includes means for mapping an assurance intent. For example, the means for mapping an assurance intent may be implemented by assurance intent mapper circuitry 408. In some examples, the assurance intent mapper circuitry 408 may be instantiated by programmable circuitry such as the example programmable circuitry 1512 of FIG. 15. For instance, the assurance intent mapper circuitry 408 may be instantiated by the example microprocessor 1800 of FIG. 18 executing machine executable instructions such as those implemented by at least blocks 608, 610, 615 of FIG. 6. In some examples, the assurance intent mapper circuitry 408 may be instantiated by hardware logic circuitry, which may be implemented by an ASIC, XPU, or the FPGA circuitry 1900 of FIG. 19 structured to perform operations corresponding to the machine readable instructions. Additionally or alternatively, the assurance intent mapper circuitry 408 may be instantiated by any other combination of hardware, software, and/or firmware. For example, the assurance intent mapper circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating an alert. For example, the means for generating an alert may be implemented by alert generator circuitry 410. In some examples, the alert generator circuitry 410 may be instantiated by programmable circuitry such as the example programmable circuitry 1512 of FIG. 15. For instance, the alert generator circuitry 410 may be instantiated by the example microprocessor 1800 of FIG. 18 executing machine executable instructions such as those implemented by at least block 630 of FIG. 6. In some examples, the alert generator circuitry 410 may be instantiated by hardware logic circuitry, which may be implemented by an ASIC, XPU, or the FPGA circuitry 1900 of FIG. 19 structured to perform operations corresponding to the machine readable instructions. Additionally or alternatively, the alert generator circuitry 410 may be instantiated by any other combination of hardware, software, and/or firmware. For example, the alert generator circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

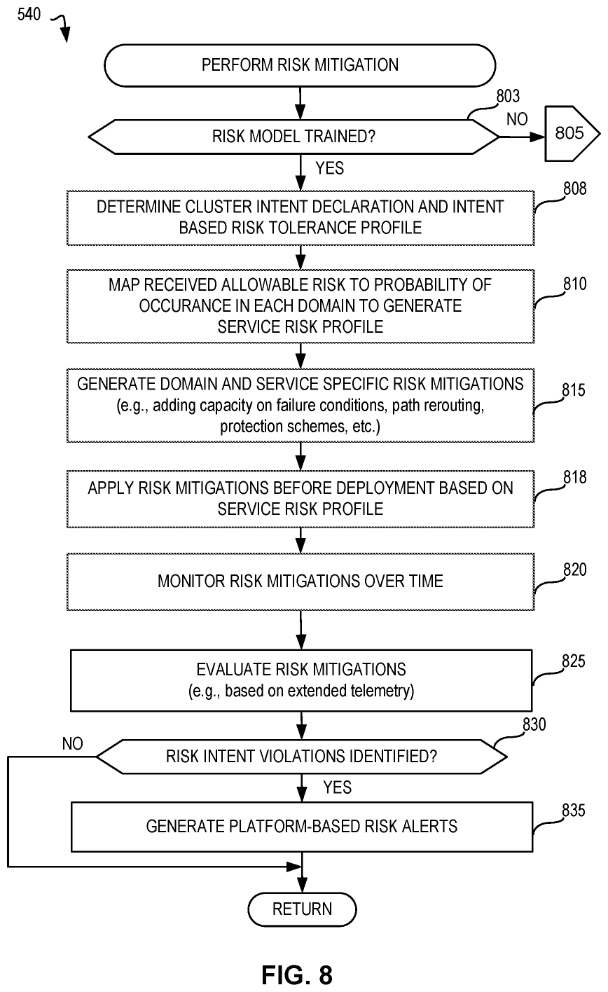

In some examples, the apparatus includes means for mapping a risk. For example, the means for mapping a risk may be implemented by risk mapper circuitry 412. In some examples, the risk mapper circuitry 412 may be instantiated by programmable circuitry such as the example programmable circuitry 1512 of FIG. 15. For instance, the risk mapper circuitry 412 may be instantiated by the example microprocessor 1800 of FIG. 18 executing machine executable instructions such as those implemented by at least block 810 of FIG. 8. In some examples, the risk mapper circuitry 412 may be instantiated by hardware logic circuitry, which may be implemented by an ASIC, XPU, or the FPGA circuitry 1900 of FIG. 19 structured to perform operations corresponding to the machine readable instructions. Additionally or alternatively, the risk mapper circuitry 412 may be instantiated by any other combination of hardware, software, and/or firmware. For example, the risk mapper circuitry 412 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for assessing a risk. For example, the means for assessing a risk may be implemented by risk assessment controller circuitry 414. In some examples, the risk assessment controller circuitry 414 may be instantiated by programmable circuitry such as the example programmable circuitry 1512 of FIG. 15. For instance, the risk assessment controller circuitry 414 may be instantiated by the example microprocessor 1800 of FIG. 18 executing machine executable instructions such as those implemented by at least block 820 of FIG. 8. In some examples, the risk assessment controller circuitry 414 may be instantiated by hardware logic circuitry, which may be implemented by an ASIC, XPU, or the FPGA circuitry 1900 of FIG. 19 structured to perform operations corresponding to the machine readable instructions. Additionally or alternatively, the risk assessment controller circuitry 414 may be instantiated by any other combination of hardware, software, and/or firmware. For example, the risk assessment controller circuitry 414 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the orchestrator controller circuitry 302 of FIG. 3 is illustrated in FIG. 4, one or more of the elements, processes and/or devices illustrated in FIG. 4 may be combined, divided, re-arranged, omitted, eliminated and/or implemented in any other way. Further, the example orchestrator interface generator circuitry 402, resource management controller circuitry 404, workload scheduler circuitry 406, assurance intent mapper circuitry 408, alert generator circuitry 410, risk mapper circuitry 412, and/or risk assessment controller circuitry 414, and/or, more generally, the example orchestrator controller circuitry 302 of FIG. 3 may be implemented by hardware, software, firmware and/or any combination of hardware, software and/or firmware. Thus, for example, any of the example orchestrator interface generator circuitry 402, resource management controller circuitry 404, workload scheduler circuitry 406, assurance intent mapper circuitry 408, alert generator circuitry 410, risk mapper circuitry 412, and/or risk assessment controller circuitry 414, and/or, more generally, the example orchestrator controller circuitry 302 of FIG. 3 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the orchestrator controller circuitry 302 of FIG. 3 may include one or more elements, processes, and/or devices in addition to, or instead of, those illustrated in FIG. 4, and/or may include more than one of any or all of the illustrated elements, processes and devices.

Flowcharts representative of example machine readable instructions, which may be executed by programmable circuitry to implement and/or instantiate the orchestrator controller circuitry 302 of FIG. 3 and/or representative of example operations which may be performed by programmable circuitry to implement and/or instantiate the orchestrator controller circuitry 302 of FIG. 3, are shown in FIGS. 5-9. The machine readable instructions may be one or more executable programs or portion(s) of one or more executable programs for execution by programmable circuitry, such as the programmable circuitry 1512 shown in the example processor platform 1500 discussed below in connection with FIG. 15 and/or may be one or more function(s) or portion(s) of functions to be performed by the example programmable circuitry (e.g., an FPGA) discussed below in connection with FIGS. 18 and/or 19. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 5-9, many other methods of implementing the example orchestrator controller circuitry 302 of FIG. 3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, and/or activities, the phrase “at least one of A and B” is intended to refer to implementations including any of (1) at least one A, (2) at least one B, or (3) at least one A and at least one B. Similarly, as used herein in the context of describing the performance or execution of processes, instructions, actions, and/or activities, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to implement the example orchestrator controller circuitry 302 of FIG. 4. The machine readable instructions and/or the operations 500 of FIG. 5 begin at block 505, at which the orchestrator interface generator circuitry 402 receives telemetry data from the edge platform (e.g., corresponding to edge platform circuitry 300). For example, the orchestrator interface generator circuitry 402 receives information about the utilization of platform resources (e.g., hardware resources, software resources, virtual hardware and/or software resources, etc.), and the efficiency with which those resources are able to meet the demands placed on them. In the example of FIG. 5, the orchestrator interface generator circuitry 402 transmits the telemetry data to the resource management controller circuitry 404. The resource management controller circuitry 404 performs resource allocation at block 510. For example, the resource management controller circuitry 404 manages resource consumption of resource(s) by orchestration components and/or other components of the edge platform. In some examples, the resource management controller circuitry 404 determines the amount of resources to be utilized by various services, applications, and/or workloads assigned to the edge platform to meet the respective SLAs associated with each of the services, applications, and/or workloads. As such, the resource management controller circuitry 404 determines what quantity of resources may be released from, or made available to, the orchestration components at the edge platform. Subsequently, the workload scheduler circuitry 406 schedules workload(s) to execute at the edge platform, at block 515. For example, the workload scheduler circuitry 406 accesses a task and provides the task one or more of the resources at an edge platform to execute or complete.

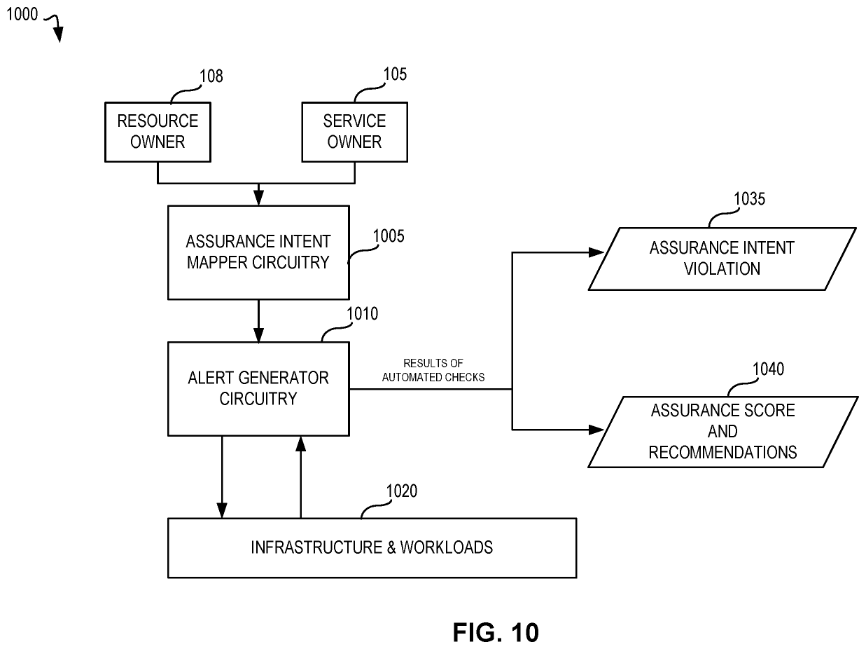

In the example of FIG. 5, the assurance intent mapper circuitry 408 determines whether a service assurance request has been received, at block 520. For example, the service assurance request can be received from the service owner 105 of FIG. 1, as shown in more detail in connection with FIGS. 10 and/or 11. For example, the service owner 105 may want to assure the operation of a 5G core. In some examples, the resource owner 108 of FIG. 1 can provide a cluster level intent (e.g., specify percentage of nodes in a cluster with a percentage of assurance cover, etc.), as well as information pertaining to coverage of an orchestration control plane, high availability (HA) deployment coverage, storage assurance coverage, etc. If the assurance intent mapper circuitry 408 determines that the service assurance request has been received, the assurance intent mapper circuitry 408 proceeds, at block 525, to map assurance intents and, in some examples, also evaluate intent-based assurance effectiveness, as described in more detail in connection with FIG. 6. Once the assurance intent mapper circuitry 408 completes mapping of the assurance intents, the orchestrator interface generator circuitry 402 deploys active probe(s) after reservation of compute resources for the active probe(s), at block 530. Once the assurance intent mapper circuitry 408 completes mapping assurance intents and/or determines that a service assurance request has not been received, the risk mapper circuitry 412 determines whether a cluster intent declaration has been received, at block 535. If the risk mapper circuitry 412 receives a cluster intent declaration, the risk mapper circuitry 412 performs risk mitigation, at block 540. For example, as described in connection with FIG. 8, the risk mapper circuitry 412 maps a risk intent to deployment methods and mitigations. For example, the risk mapper circuitry 412 sends a trigger to the resource orchestrator to rebalance/reprovision workloads to operate around the identified sources of identified risk(s).

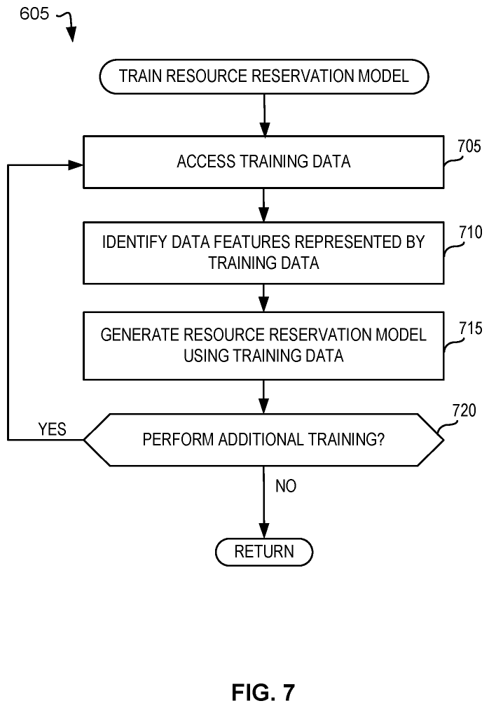

FIG. 6 is a flowchart representative of example machine readable instructions and/or example operations 525 of FIG. 5 that may be executed, instantiated, and/or performed by programmable circuitry to implement the example assurance intent mapper circuitry 408 and/or the example alert generator circuitry 410 of FIG. 4. The machine readable instructions and/or the operations 525 of FIG. 5 begin at block 602, at which the assurance intent mapper circuitry 408 determines whether the resource reservation model has been trained. If the resource reservation model has not been trained, control proceeds to block 605 of FIG. 7, where the assurance intent mapper circuitry 408 performs training of the resource reservation model. If the resource reservation model has been trained, at block 608 the assurance intent mapper circuitry 408 identifies the service assurance request (e.g., received from the service owner). The assurance intent mapper circuitry 408 generates a domain assurance profile, policies, and/or checks based on the service assurance request, at block 610. In some examples, the assurance intent mapper circuitry 408 generates assurance contexts tied to specific assurance service level objectives (SLOs). Subsequently, the assurance intent mapper circuitry 408 reserves compute resource(s) for passive probes and on-demand probes, at block 615.

As previously described, probes can be used for monitoring and gathering of information about events affecting containers and/or collecting telemetry information. In some examples, the probes can be used to indicate whether a container is operating, whether an application running in the container is ready to accept requests, and/or whether an application running in the container has started, etc. In some examples, an ‘on-demand probe’ is an active probe that is inserted into an operational network at specific points (e.g., by the management system) to determine the root cause of an issue, where the term ‘on-demand’ indicates that probes can be inserted based on any number of conditions and at any point in the network for root cause analysis and/or troubleshooting (e.g., Extended Berkeley Packet Filter (EBPF) probes used for monitoring networking in a cloud environment). Furthermore, service assurance can rely on passive probing and/or active probing as measurement techniques for evaluating service performance. In some examples, passive probes monitor traffic flows and do not impact the services themselves (e.g., passive probes reading probe level statistics, etc.). For example, passive probes can be engineered into a given network to obtain detailed information at key points. Conversely, in some examples, active probes insert synthetic test traffic into a network and observe how the network and/or a service responds, allowing the active probe to measure service performance. Active probes can be used for generating real-time performance data on specific services. In some examples, active probes can be used in services with performance-based SLAs ensure fulfillment of service agreements.

In some examples, the assurance intent mapper circuitry 408 reserves compute resources based on the resource reservation model(s) and/or policy governance. For example, the assurance intent mapper circuitry 408 can reserve resources (e.g., a dedicated server, memory bandwidth, cache, interface bandwidth, etc.) for the co-deployment of an active probe on demand. In some examples, the assurance intent mapper circuitry 408 determines whether to forcefully free up capacity and/or whether to perform freeing or scaling down of deployed workload capacity in accordance with the trained resource reservation model described in connection with FIG. 7. As such, the orchestrator controller circuitry 302 can deploy active probes to the compute resources reserved for the active probe. In some examples, the assurance intent mapper circuitry 408 uses policy governance to determine whether to use a permanent reserve or forceful deploy pattern.

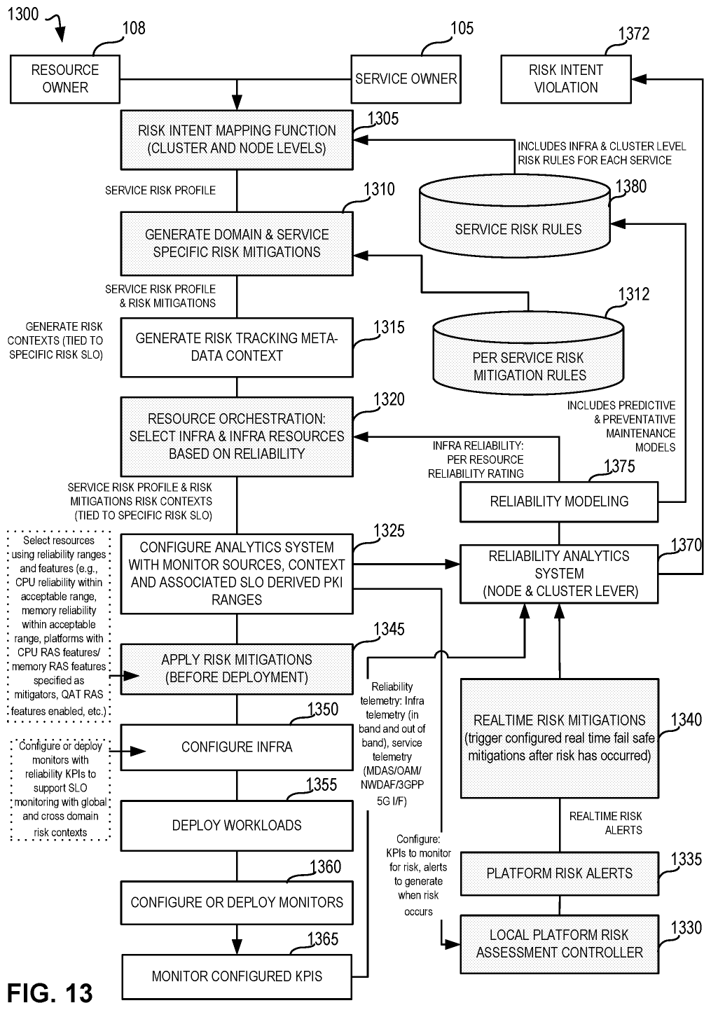

In the example of FIG. 6, the assurance intent mapper circuitry 408 determines whether evaluation of intent-based assurance effectiveness is to be performed (e.g., based on service owner request, etc.), at block 618. If intent-based assurance effectiveness performance is to be assessed, at block 620 the alert generator circuitry 410 generates an assurance score. For example, the alert generator circuitry 410 calculates an overall score indicating the number of intents met (e.g., a percentage of intents met, etc.). If the alert generator circuitry 410 determines that the intent(s) are not met (e.g., based on the overall score not satisfying (e.g., being less than) a target threshold of intents to be met, etc.), at block 625, the alert generator circuitry 410 generates an alert identifying assurance intent violation, at block 630. If the alert generator circuitry 410 determines that the intent is met (e.g., based on the overall score satisfying (e.g., being greater than or equal to) the target threshold of intents to be met, etc.), at block 625, the alert generator circuitry 410 outputs the final assurance score and any recommendations associated with meeting the assurance intent, at block 635, as shown in more detail in connection with FIG. 13.

FIG. 7 is a flowchart representative of example machine readable instructions and/or example operations 605 that may be executed, instantiated, and/or performed by programmable circuitry to implement the example assurance intent mapper circuitry 408 of FIG. 4 to train a resource reservation model. The machine readable instructions and/or the operations 605 of FIG. 7 begin at block 705, at which the assurance intent mapper circuitry 408 accesses training data 438. The training data 438 can include results from previous freeing up or scaling down of deployed workload capacity to determine which resource reservation approach is most effective for a given task (e.g., based on whether a permanent reserve or a forceful deploy pattern can be used for reservation of active probes). In some examples, the training data is labeled. In some examples, the training data is sub-divided such that a portion of the data is used for validation purposes. The trainer 442 identifies data features represented by the training data 438, at block 710. In some examples, the training controller 440 instructs the trainer 442 to perform training of the neural network using the training data 438 to generate a resource reservation model 448, at block 715. In some examples, additional training is performed to refine the resource reservation model 448, at block 720.

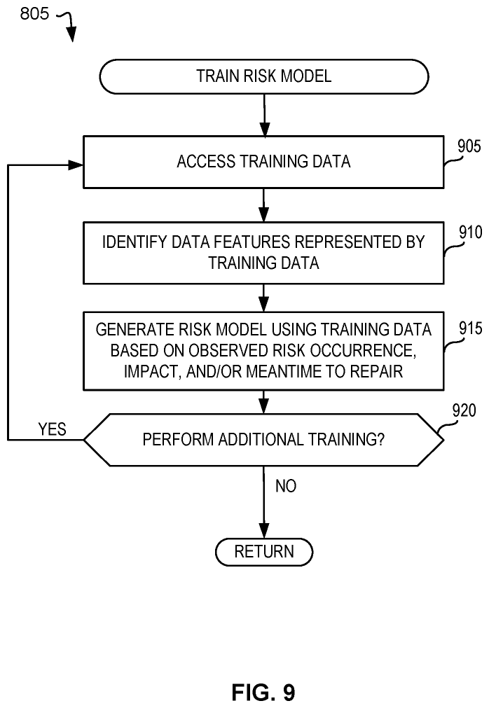

FIG. 8 is a flowchart representative of example machine readable instructions and/or example operations 540 of FIG. 5 that may be executed, instantiated, and/or performed by programmable circuitry to implement the example risk mapper circuitry 412 and/or the example risk assessment controller circuitry 414 of FIG. 4. The machine readable instructions and/or the operations 540 of FIG. 5 begin at block 803, at which the risk mapper circuitry 412 determines whether the risk model is trained. If the risk mapper circuitry 412 determines that the risk model is not trained, control proceeds to block 805, at which the risk mapper circuitry 412 proceeds to train the risk model(s), as described in more detail in connection with FIG. 9. If the risk mapper circuitry 412 determines that the risk model is trained, the risk mapper circuitry 412 identifies cluster intent declaration(s) and intent based risk tolerance profile(s). The intent based risk tolerance profile can represent intent-based service level objectives (SLOs), with risk determined based on the type of service, allowable outage time, allowable number of users impacted, allowable cost, etc. In some examples, the resource owner-based cluster intent declaration is different from the service owner (e.g., different view, allowable time to repair, allowable cost to repair, cooling and site redundancy responsibility, etc.). In the example of FIG. 8, the risk mapper circuitry 412 generates a service risk profile by mapping the received allowable risk to a probability of occurrence of the risk in each domain (e.g., infra, software, switching, cluster, Kubernetes, etc.), at block 810. For example, the service risk profile is the probability of risk occurrence in each domain where impact and/or cost to repair are used as inputs. Based on the generated service risk profile, the risk mapper circuitry 412 generates domain and/or service specific risk mitigations, at block 815. In some examples, the risk mapper circuitry 412 uses the risk model to determine risks over time, based on observed risk occurrence, impact and meantime to repair, such that a risk model is associated with each layer of the stack. For example, the risk mapper circuitry 412 uses a risk model for the orchestration layer, infrastructure layer, service orchestration layer, monitor and analytics layer, etc. The risk mapper circuitry 412 generates domain and/or service specific risk mitigations including, for example, selection of resources using reliability ranges and reliability features (e.g., CPU reliability within acceptable range, memory reliability within acceptable range, etc.). In some examples, the risk mapper circuitry 412 sends a trigger to the resource orchestrator to rebalance/reprovision workloads to operate around the identified sources of risk.

In the example of FIG. 8, the risk mapper circuitry 412 applies risk mitigation(s) before deployment of a particular service based on the service risk profile, at block 818. For example, the risk mitigations can include adding capacity on failure conditions, performing path rerouting, utilizing protection schemes, etc. In some examples, the risk assessment controller circuitry 414 monitors risk mitigations over time, at block 820. For example, the risk assessment controller circuitry 414 performs risk assessment at a local level or at a cluster level. In some examples, the risk assessment controller circuitry 414 evaluates risk mitigations (e.g., based on extended telemetry), at block 825. For example, the risk assessment controller circuitry 414 performs risk assessment at a local level by analyzing performance metrics and generating real time alerts when risk mitigations are removed and/or a platform is misconfigured. As such, the risk assessment controller circuitry 414 can identify the type(s) of risk mitigations that are most effective and the risk mapper circuitry 412 can use such monitoring results for subsequent training of the risk model(s). In the example of FIG. 8, if the risk assessment controller circuitry 414 identifies a risk intent violation, the risk assessment controller circuitry 414 generates an alert (e.g., when a platform risk occurs and/or real-time risk mitigations are triggered after the risk has occurred), at block 835. For example, the risk assessment controller circuitry 414 analyzes cluster metrics and generates real-time alerts when cluster level risk mitigations are removed or misconfigured. Likewise, the risk assessment controller circuitry 414 generates alerts when the cluster cannot support a risk, as described in more detail in connection with FIG. 4.

FIG. 9 is a flowchart representative of example machine readable instructions and/or example operations 805 that may be executed, instantiated, and/or performed by programmable circuitry to implement the example risk mapper circuitry 412 of FIG. 4 to train a risk model. The machine readable instructions and/or the operations 805 of FIG. 8 begin at block 905, at which the risk mapper circuitry 412 accesses training data 458. The training data 458 can include results from observed risk occurrence, meantime to repair an error, etc. In some examples, the training data can include success of particular risk mitigations (e.g., adding capacity on failure conditions, performing path rerouting, utilizing protection schemes, etc.). In some examples, the training data is labeled. In some examples, the training data is sub-divided such that a portion of the data is used for validation purposes. The trainer 462 identifies data features represented by the training data 458, at block 910. In some examples, the training controller 460 instructs the trainer 462 to perform training of the neural network using the training data 458 to generate a risk model 468, at block 915. In some examples, additional training is performed to refine the risk model 468, at block 920.

FIG. 10 is an example diagram 1000 illustrating example operations performed by the assurance intent mapper circuitry 408 and the alert generator circuitry 410 of FIG. 4 to assess assurance intent violation(s) and assurance score and recommendations in accordance with the machine-readable instructions and/or operations of FIGS. 5-7. In the example of FIG. 10, input(s) are received (e.g., by the orchestrator controller circuitry 302) from the service owner (e.g., service owner 105 of FIG. 1) and/or the resource owner (e.g., resource owner 108 of FIG. 1). As described in connection with FIGS. 5-7, the assurance intent mapper circuitry 408 of FIG. 4 can generate a domain assurance profile, policies, and/or checks, reserve computer resources for passive probes and/or on-demand probes, and/or perform assurance checks based on policy (block 1005), while interacting with the infrastructure and/or workloads of the edge computing system (block 1020). In some examples, the alert generator circuitry 410 of FIG. 4 generates an assurance score based on results obtained using automated checks. In some examples, the alert generator circuitry 410 generates an alert if intent(s) are not met and outputs an assurance intent violation (block 1035). In some examples, the alert generator circuitry 410 outputs the assurance score and/or recommendations if the intent(s) are met (block 1040).

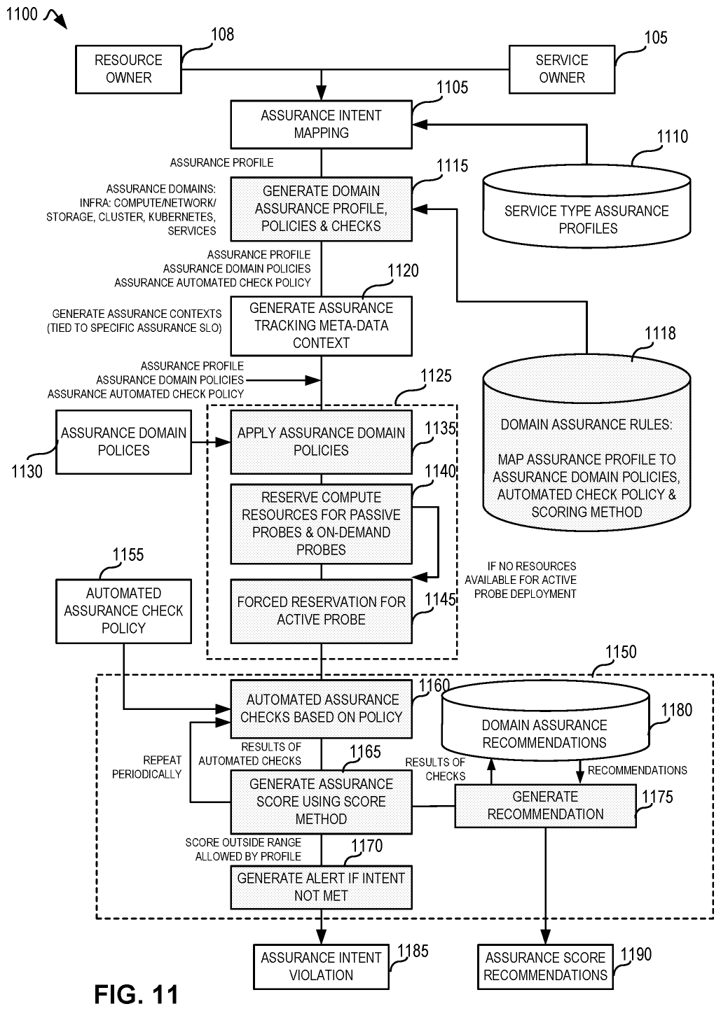

FIG. 11 is an example diagram 1100 illustrating example operations performed by the assurance intent mapper circuitry 408 and/or the alert generator circuitry 410 to implement intent-based service level objectives for service assurance, including assessing assurance intent violation(s) and assurance score and recommendations. In the example of FIG. 11, inputs from the resource owner 108 and/or the service owner 105 are used for assurance intent mapping (block 1105). For example, the service owner 105 may be interested in assuring the operation of a 5G core and in actively assessing root cause issues using both passive and active assurance methods. The resource owner 108 may be involved in the cluster level intents (e.g., specifying a percentage of nodes in a cluster with a percentage of assurance coverage based on the received service assurance request, etc.). For example, the assurance coverage can relate to meeting assurance intents based on a user's request to employ both passive and active assurance methods. In some examples, the assurance coverage can be tied to deployment and activation of platform collectors, reachability of platform collectors, deployment of monitoring systems, accessibility of monitoring systems, etc. In some examples, the resource owner 108 can be involved with coverage of the orchestration control plane, HA deployment coverage, and/or storage and assurance coverage. As previously described, the assurance intent mapper circuitry 408 generates domain, assurance profile, policies, and checks (block 1115). For example, the assurance intent mapping function can be performed based on input from a service type assurance profile(s) database 1110, while domain, assurance profile, policies, and checks generation can be performed based on a domain assurance rules database (block 1118). In some examples, the assurance intent mapper circuitry 408 generates an assurance tracking meta-data context (e.g., tied to specific assurance service level objectives (SLOs), etc.) (block 1120). As previously described in connection with FIG. 6, based on assurance domain policies (block 1130), the intent assurance mapper circuitry 408 applies assurance domain policies (block 1135), reserves compute resources for passive probes and on-demand probes (block 1140), and may proceed with forced reservation for active probe(s) (e.g., if no resources are available for active probe deployment) (block 1145). In the example of FIG. 11, the assurance intent mapper circuitry 408 performs the application of policies, reservation of compute resources, and/or forced reservation(s) as part of block 1125, while the alert generator circuitry 410 performs automated assurance checks, generates assurance score(s), generates alert(s), and/or generates recommendation(s) as part of block 1150. For example, the alert generator circuitry 410 performs automated assurance checks based on policy (block 1160) (e.g., based on the automated assurance check policy 1155). Subsequently, the alert generator circuitry 410 generates assurance score(s) using the score method (block 1165), as described in connection with FIG. 6. In some examples, the alert generator circuitry 410 periodically repeats the process of generating the assurance score and performing automated assurance checks based on a given policy. In some examples, the alert generator circuitry 410 generates an alert if an intent is not met (block 1170). If the intent(s) are met, the alert generator circuitry 410 generates a recommendation (block 1175) and stores the generated recommendation in a domain assurance recommendations database (block 1180). If the intent(s) are not met, the alert generator circuitry 410 outputs an assurance intent violation notice (block 1185). In some examples, the alert generator circuitry 410 also outputs assurance score recommendations (block 1190) based on the generated assurance score(s).

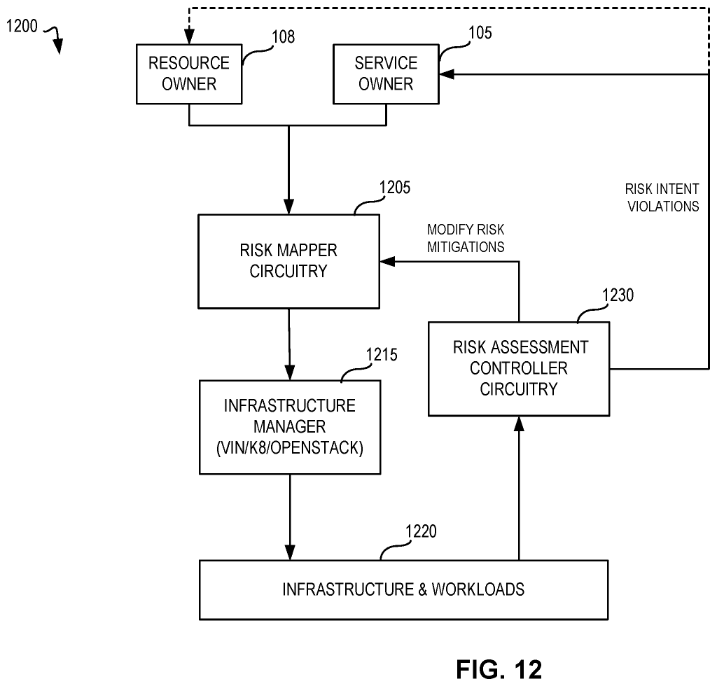

FIG. 12 is an example diagram 1200 illustrating example operations performed by the risk mapper circuitry 408 and the risk assessment controller circuitry 414 to identify risk intent violations and modify risk mitigations in accordance with the machine-readable instructions and/or operations of FIGS. 5, and 8-9. In the example of FIG. 12, input(s) are received from the service owner (e.g., service owner 105 of FIG. 1) and/or the resource owner (e.g., resource owner 108 of FIG. 1). As described in connection with FIGS. 8-9, the risk mapper circuitry 408 of FIG. 4 can generate risk mitigation(s) and/or apply risk mitigation(s) (block 1205), and communicate with an infrastructure manager (block 1215), while interacting with the edge computing infrastructure and/or workload(s) (block 1220). In some examples, the risk assessment controller circuitry 414 of FIG. 4 monitors risk mitigation(s) and/or evaluates risk mitigations (block 1230). In some examples, the risk mapper circuitry 408 modifies risk mitigation(s) based on the risk mitigation evaluation performed by the risk assessment controller circuitry 414, as described in more detail in connection with FIG. 8. In some examples, the risk assessment controller circuitry 414 informs the service owner 105 and/or the resource owner 108 of risk intent violation(s).

FIG. 13 is an example diagram 1300 illustrating example operations performed by the risk mapper circuitry 408 and/or the risk assessment controller circuitry 414 to implement mitigation of risk based on pre-planned resource allocation, configuration scaling, task migration, and resource sequestrations, including identification of risk intent violations and modification of risk mitigations. As described in connection with FIGS. 8-9, the risk mapper circuitry 408 performs risk intent mapping at cluster and node levels (block 1305), generates domain and service specific risk mitigations (block 1310), and/or generates risk tracking meta-data context(s) (block 1315). In some examples, the risk mapper circuitry 408 receives data from a per service risk mitigation rules database (block 1312) to assist with generating domain and service specific risk mitigations. In some examples, the orchestrator interface generator circuitry 102 selects infrastructure resources based on reliability (block 1320) (e.g., based on input(s) associated with reliability modeling). In some examples, the orchestrator interface generator circuitry 102 configures analytics system(s) with monitor sources, context and/or associated service level objective (SLO) derived public key infrastructure (PKI) ranges (block 1325). For example, the orchestrator interface generator circuitry 102 selects resources using reliability ranges and features (e.g., CPU reliability within acceptable range, memory reliability within acceptable range, platforms with CPU RAS features/memory RAS features, QAT RAS features enabled, etc.). In some examples, the configuration includes key performance indicators (KPIs) to monitor for risk and/or alerts to generate when risk occurs. In examples disclosed herein, the risk assessment controller circuitry 414 of FIG. 4 executes as a local platform risk assessment controller (block 1330). For example, the risk assessment controller circuitry 414 generates platform risk alerts (block 1335) and the risk mapper circuitry 408 triggers configured real-time fail-safe mitigations after a risk has occurred (e.g., real-time risk alert generated, etc.) (block 1340).

In examples disclosed herein, the risk mapper circuitry 408 applies risk mitigations (e.g., prior to service deployment) (block 1345). Subsequently, the orchestrator interface generator circuitry 102 configures the infrastructure (e.g., by configuring or deploying monitors with reliability KPIs to support SLO monitoring with global and cross domain risk contexts, etc.) (block 1350). For example, the workload scheduler circuitry 406 deploys workloads (block 1355) and configures or deploys monitors and/or probes (block 1360), resulting in the monitoring of configured key performance indicators (KPIs) (e.g., frames per second, floating point operations per second, latency goals, etc.) of an application (e.g., service, workload, etc.) (block 1365). In the example of FIG. 13, a reliability analytics system receives reliability telemetry (e.g., infrastructure telemetry) (block 1370). In some examples, the reliability analytics system generates a risk intent violation (block 1372). In some examples, the reliability analytics system receives input(s) from the analytics system configuration(s) (block 1325). In some examples, reliability modeling results (block 1375) can be provided to a service risk rules database 1380. In the example of FIG. 13, the service risk rules can include infrastructure and cluster level risk rules for each service. In some examples, reliability modeling data (e.g., per resource reliability rating) is provided to the orchestrator interface generator circuitry 102 for resource orchestrations used to select infrastructure resources based on reliability (block 1320).

In the example of FIG. 13, infrastructure risk examples include recoverable memory module failure, unrecoverable memory module failure, recoverable CPU failure, unrecoverable CPU failure, recoverable accelerator failure EG QAT, AI Accelerator, GPU unrecoverable accelerator failure EG QAT, AI Accelerator, GPU unrecoverable SSD/NVME failure, recoverable network interface failure, unrecoverable network interface failure, recoverable network congestion, unrecoverable network congestion, VS witch overload/congestion, service mesh congestion/faults, operating system resource contention leading to stalls, service/platform un-reachable due to platform resets/network failure, service response time/transaction time/latency outside allowable range, earthquake, fire, and/or power outage. In some examples, there exist risk correlations and/or influences between different risks. For example, recoverable CPU/Memory/Accelerator faults can cause network congestion, unrecoverable CPU/Memory/Accelerator faults can cause platform resets that make the service and platform un-reachable, in the event of a heating or cooling infrastructure failure (e.g., HVAC or local cooling with fans/immersion) multiple recoverable and un-recoverable errors may be generated before the platform performs a reset due to thermal over-run, recoverable errors can trend over time to become un-recoverable errors (e.g., this can be tracked as a risk), and bad code pushed to the server can result in network congestion and other service degradation including response time.

Expressing risk includes risk input rates that can be applied (e.g., frequency). In some examples, risk is dimensionless, but still indicates a need to “understand” and/or transparently communicate the risk. Risk normalization across various stakeholders (e.g., service owners, resource owners) can be beneficial. Risk assessments can change over time/dynamicity. In some examples, risk hierarchy can be developed, up leveling the risk from a K8S centric cluster view into generically termed aggregation zones and data centers. In examples disclosed herein, hardware risk mitigation features (e.g., sub-NUMA clusters (SNCs)) include mapping of different properties of the platform and node architecture that may provide different features that could be used to mitigate risk. For example, an SNC creates two localization domains within a processor by mapping addresses from a first local memory controller in one half of last level cache (LLC) slices closer to the first memory controller and addresses mapped to a second memory controller into the LLC slices in another half. Through this address-mapping mechanism, processes running on cores on one of the SNC domains using memory from the memory controller in the same SNC domain observe lower LLC and memory latency compared to latency on accesses mapped to locations outside of the same SNC domain. For example, SNC can be used to create independent compute domains within a central processing unit (CPU), with different types of interleaving to have different domain-based memory corruption. In some examples, a computer express link (CXL) can be used to isolate different elements of the architecture. Each of those “knobs” has implications that need to be handled and matched with respect to the application or service KPIs when implementing risk mitigation. In some examples, a federated or distributed compute-based architecture may contain different types of hardware nodes with different sets of risk mitigation features versus performance glass-jaws. In examples disclosed herein, this information can be captured as part of an orchestration manifest and provided to the user in different ways to express the “intent” of a risk. Fast closed-loop controller models (e.g., Intel® Resource Director Technology Dynamic Resource Controller (DRC)) could be extended to support hardware risk mitigation through dynamically switching on/off parts of the systems and supporting moving workloads away from risker components (e.g., considering a memory controller reporting higher errors, a DRC can be used to dynamically disable channels in that memory controller or the entire controller).

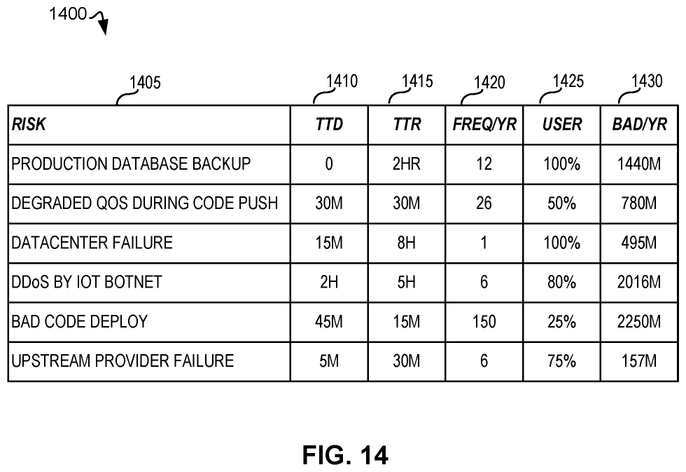

FIG. 14 illustrates example calculated expected costs 1400 associated with simple risk management budget allocations. In some examples, the risk mapper circuitry 412 determines the calculated expected costs 1400, as described in connection with FIG. 4. For example, a set of risks 1405 includes a production database backup, degraded Quality of Service (QoS) during code push, a data center failure, Distributed Denial of Service (DDoS) by an Internet of Things (IoT) BotNet, a bad code deployment, and/or an upstream provider failure. In the example of FIG. 14, each risk from the set of risks 1405 includes a total time to detect (TTD) data 1410, total time to respond (TTR) data 1415, frequency per year data 1420, percentage of user(s) data 1425, and cumulative error data per year 1430. As such, risk management is an important part of edge computing, as described in the examples disclosed herein.

FIG. 15 is a block diagram of an example programmable circuitry platform 1500 structured to execute and/or instantiate the example machine-readable instructions and/or the example operations of FIGS. 5, 6 and/or 8 to implement the example orchestrator controller circuitry 302 of FIG. 4. The programmable circuitry platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs microprocessors, CPUs, GPUs, DSPs, and/or microcontrollers from any desired family or manufacturer. The programmable circuitry 1512 may be implemented by one or more semiconductor based (e.g., silicon based) devices. In this example, the processor circuitry 1512 implements the orchestrator interface generator circuitry 402, the resource management controller circuitry 404, the workload scheduler circuitry 406, the assurance intent mapper circuitry 408, the alert generator circuitry 410, the risk mapper circuitry 412, and/or the risk assessment controller circuitry 414.

The programmable circuitry 1512 of the illustrated example includes a local memory 1513 (e.g., a cache, registers, etc.). The programmable circuitry 1512 of the illustrated example is in communication with a main memory including a volatile memory 1514 and a non-volatile memory 1516 by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512. The input device(s) 1522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1524 are also connected to the interface circuitry 1520 of the illustrated example. The output devices 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1500 of the illustrated example also includes one or more mass storage devices 1528 to store software and/or data. Examples of such mass storage devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1532, which may be implemented by the machine readable instructions of FIGS. 5, 6, and/or 8, may be stored in the mass storage device 1528, in the volatile memory 1514, in the non-volatile memory 1516, and/or on at least one non-transitory computer readable storage medium such as a CD or DVD which may be removable.

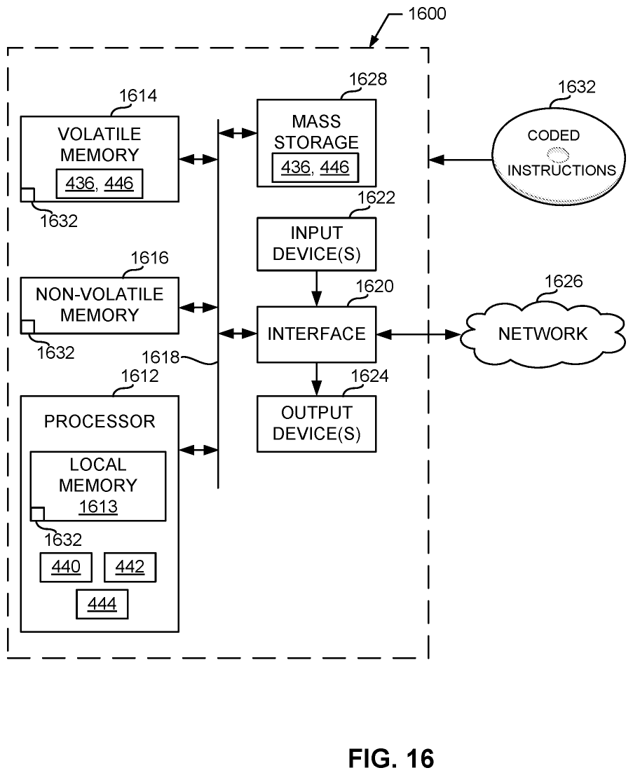

FIG. 16 is a block diagram of an example programmable circuitry platform 1600 structured to execute and/or instantiate the example machine-readable instructions and/or the example operations of FIG. 7 to implement the example first computing system 430 of FIG. 4. The programmable circuitry platform 1600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1600 of the illustrated example includes programmable circuitry 1612. The programmable circuitry 1612 of the illustrated example is hardware. For example, the programmable circuitry 1612 can be implemented by one or more integrated circuits, logic circuits, FPGAs microprocessors, CPUs, GPUs, DSPs, and/or microcontrollers from any desired family or manufacturer. The programmable circuitry 1612 may be implemented by one or more semiconductor based (e.g., silicon based) devices. In this example, the programmable circuitry 1612 implements the example neural network processor 444, the example trainer 442, and the example training controller 440.

The programmable circuitry 1612 of the illustrated example includes a local memory 1613 (e.g., a cache, registers, etc.). The programmable circuitry 1612 of the illustrated example is in communication with a main memory including a volatile memory 1614 and a non-volatile memory 1616 by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617. In some examples, the memory controller 1617 may be implemented by one or more integrated circuits, logic circuits, microcontrollers from any desired family or manufacturer, or any other type of circuitry to manage the flow of data going to and from the main memory 1614, 1616.

The programmable circuitry platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1622 are connected to the interface circuitry 1620. The input device(s) 1622 permit(s) a user (e.g., a human user, a machine user, etc.) to enter data and/or commands into the programmable circuitry 1612. The input device(s) 1622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1624 are also connected to the interface circuitry 1620 of the illustrated example. The output devices 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1600 of the illustrated example also includes one or more mass storage devices 1628 to store software and/or data. Examples of such mass storage devices 1628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1632, which may be implemented by the machine readable instructions of FIG. 7, may be stored in the mass storage device 1628, in the volatile memory 1614, in the non-volatile memory 1616, and/or on at least one non-transitory computer readable storage medium such as a CD or DVD which may be removable.

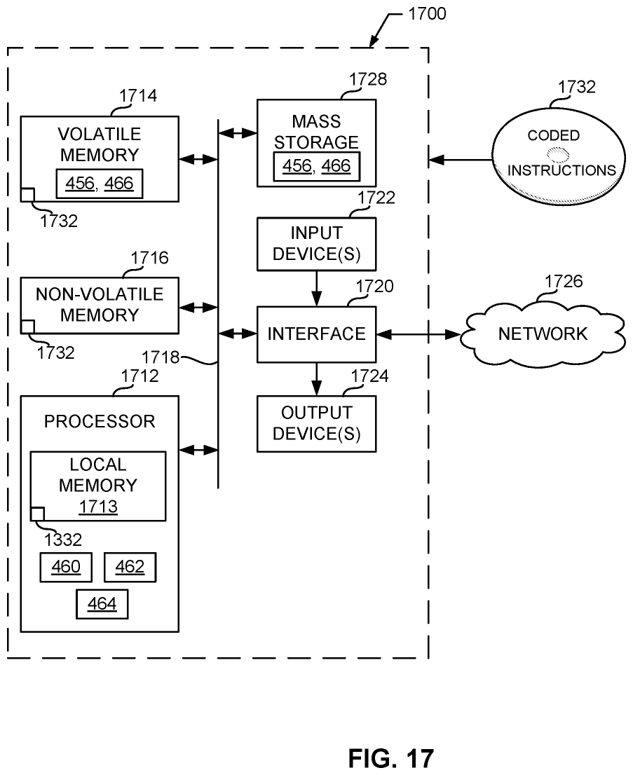

FIG. 17 is a block diagram of an example programmable circuitry platform 1700 structured to execute and/or instantiate the example machine-readable instructions and/or the example operations of FIG. 9 to implement the example second computing system 450 of FIG. 4. The programmable circuitry platform 1700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1700 of the illustrated example includes programmable circuitry 1712. The programmable circuitry 1712 of the illustrated example is hardware. For example, the programmable circuitry 1712 can be implemented by one or more integrated circuits, logic circuits, FPGAs microprocessors, CPUs, GPUs, DSPs, and/or microcontrollers from any desired family or manufacturer. The programmable circuitry 1712 may be implemented by one or more semiconductor based (e.g., silicon based) devices. In this example, the programmable circuitry 1712 implements the example neural network processor 464, the example trainer 462, and the example training controller 460.

The programmable circuitry 1712 of the illustrated example includes a local memory 1713 (e.g., a cache, registers, etc.). The programmable circuitry 1712 of the illustrated example is in communication with a main memory including a volatile memory 1714 and a non-volatile memory 1716 by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717. In some examples, the memory controller 1717 may be implemented by one or more integrated circuits, logic circuits, microcontrollers from any desired family or manufacturer, or any other type of circuitry to manage the flow of data going to and from the main memory 1714, 1716.

The programmable circuitry platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1722 are connected to the interface circuitry 1720. The input device(s) 1722 permit(s) a user (e.g., a human user, a machine user, etc.) to enter data and/or commands into the programmable circuitry 1712. The input device(s) 1722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1724 are also connected to the interface circuitry 1720 of the illustrated example. The output devices 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1700 of the illustrated example also includes one or more mass storage devices 1728 to store software and/or data. Examples of such mass storage devices 1728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1732, which may be implemented by the machine readable instructions of FIG. 9, may be stored in the mass storage device 1728, in the volatile memory 1714, in the non-volatile memory 1716, and/or on at least one non-transitory computer readable storage medium such as a CD or DVD which may be removable.

FIG. 18 is a block diagram of an example implementation of the programmable circuitry 1512, 1612, 1712 of FIGS. 15, 16, and 17. In this example, the programmable circuitry 1512, 1612, 1712 of FIGS. 15, 16, and 17 is implemented by a microprocessor 1800. For example, the microprocessor 1800 may be a general purpose microprocessor (e.g., general purpose microprocessor circuitry). The microprocessor 1800 executes some or all of the machine readable instructions of the flowchart of FIGS. 5, 6, 7, 8, and/or 9 to effectively instantiate the circuitry of FIG. 4 logic circuits to perform the operations corresponding to those machine readable instructions. In some such examples, the circuitry of FIG. 4 is instantiated by the hardware circuits of the microprocessor 1800 in combination with the instructions. For example, the microprocessor 1800 may implement multi-core hardware circuitry such as a CPU, a DSP, a GPU, an XPU, etc. Although it may include any number of example cores 1802 (e.g., 1 core), the microprocessor 1800 of this example is a multi-core semiconductor device including N cores. The cores 1802 of the microprocessor 1800 may operate independently or may cooperate to execute machine readable instructions. For example, machine code corresponding to a firmware program, an embedded software program, or a software program may be executed by one of the cores 1802 or may be executed by multiple ones of the cores 1802 at the same or different times. In some examples, the machine code corresponding to the firmware program, the embedded software program, or the software program is split into threads and executed in parallel by two or more of the cores 1802. The software program may correspond to a portion or all of the machine readable instructions and/or operations represented by the flowcharts of FIGS. 5, 6, 7, 8, and/or 9.

The cores 1802 may communicate by a first example bus 1804. In some examples, the first bus 1804 may implement a communication bus to effectuate communication associated with one(s) of the cores 1802. For example, the first bus 1804 may implement at least one of an Inter-Integrated Circuit (I2C) bus, a Serial Peripheral Interface (SPI) bus, a PCI bus, or a PCIe bus. Additionally or alternatively, the first bus 1804 may implement any other type of computing or electrical bus. The cores 1802 may obtain data, instructions, and/or signals from one or more external devices by example interface circuitry 1806. The cores 1802 may output data, instructions, and/or signals to the one or more external devices by the interface circuitry 1806. Although the cores 1802 of this example include example local memory 1820 (e.g., Level 1 (L1) cache that may be split into an L1 data cache and an L1 instruction cache), the microprocessor 1800 also includes example shared memory 1810 that may be shared by the cores (e.g., Level 2 (L2_ cache)) for high-speed access to data and/or instructions. Data and/or instructions may be transferred (e.g., shared) by writing to and/or reading from the shared memory 1810. The local memory 1820 of each of the cores 1802 and the shared memory 1810 may be part of a hierarchy of storage devices including multiple levels of cache memory and the main memory (e.g., the main memory 1814, 1816 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1802 may be referred to as a CPU, DSP, GPU, etc., or any other type of hardware circuitry. Each core 1802 includes control unit circuitry 1814, arithmetic and logic (AL) circuitry (sometimes referred to as an ALU) 1816, a plurality of registers 1818, the L1 cache 1820, and a second example bus 1822. Other structures may be present. For example, each core 1802 may include vector unit circuitry, single instruction multiple data (SIMD) unit circuitry, load/store unit (LSU) circuitry, branch/jump unit circuitry, floating-point unit (FPU) circuitry, etc. The control unit circuitry 1814 includes semiconductor-based circuits structured to control (e.g., coordinate) data movement within the corresponding core 1802. The AL circuitry 1816 includes semiconductor-based circuits structured to perform one or more mathematic and/or logic operations on the data within the corresponding core 1802. The AL circuitry 1816 of some examples performs integer-based operations. In other examples, the AL circuitry 1816 also performs floating-point operations. In yet other examples, the AL circuitry 1816 may include first AL circuitry that performs integer-based operations and second AL circuitry that performs floating point operations. In some examples, the AL circuitry 1816 may be referred to as an Arithmetic Logic Unit (ALU).

The registers 1818 are semiconductor-based structures to store data and/or instructions such as results of one or more of the operations performed by the AL circuitry 1816 of the corresponding core 1802. For example, the registers 1818 may include vector register(s), SIMD register(s), general purpose register(s), flag register(s), segment register(s), machine specific register(s), instruction pointer register(s), control register(s), debug register(s), memory management register(s), machine check register(s), etc. The registers 1818 may be arranged in a bank as shown in FIG. 18. Alternatively, the registers 1818 may be organized in any other arrangement, format, or structure including distributed throughout the core 1802 to shorten access time. The second bus 1822 may be implemented by at least one of an I2C bus, a SPI bus, a PCI bus, or a PCIe bus.

Each core 1802 and/or, more generally, the microprocessor 1800 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 1800 is a semiconductor device fabricated to include many transistors interconnected to implement the structures described above in one or more integrated circuits (ICs) contained in one or more packages.

The microprocessor 1800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1800, in the same chip package as the microprocessor 1800 and/or in one or more separate packages from the microprocessor 1800.

FIG. 19 is a block diagram of another example implementation of the programmable circuitry of 1512, 1612, 1712 of FIGS. 15, 16, and 17. In this example, the programmable circuitry 1512, 1612, 1712 of FIGS. 15, 16, and 17 is implemented by FPGA circuitry 1900. For example, the FPGA circuitry 1900 may be implemented by an FPGA. The FPGA circuitry 1900 can be used, for example, to perform operations that could otherwise be performed by the example microprocessor 1800 of FIG. 18 executing corresponding machine readable instructions. However, once configured, the FPGA circuitry 1900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1800 of FIG. 18 described above (which is a general purpose device that may be programmed to execute some or all of the machine readable instructions represented by the flowcharts of FIGS. 5, 6, 7, 8, and/or 9 but whose interconnections and logic circuitry are fixed once fabricated), the FPGA circuitry 1900 of the example of FIG. 19 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 5, 6, 7, 8, and/or 9. In particular, the FPGA 1900 may be thought of as an array of logic gates, interconnections, and switches. The switches can be programmed to change how the logic gates are interconnected by the interconnections, effectively forming one or more dedicated logic circuits (unless and until the FPGA circuitry 1900 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 5, 6, 7, 8, and/or 9. As such, the FPGA circuitry 1900 may be configured and/or structured to effectively instantiate some or all of the operations/functions corresponding to the machine readable instructions of the flowcharts of FIGS. 5, 6, 7, 8, and/or 9 as dedicated logic circuits to perform the operations/functions corresponding to those software instructions in a dedicated manner analogous to an ASIC. Therefore, the FPGA circuitry 1900 may perform the operations/functions corresponding to the some or all of the machine readable instructions of FIGS. 5, 6, 7, 8, and/or 9 faster than the general-purpose microprocessor can execute the same.

In the example of FIG. 19, the FPGA circuitry 1900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1900 of FIG. 19 may access and/or load the binary file to cause the FPGA circuitry 1900 of FIG. 19 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1900 of FIG. 19 to cause configuration and/or structuring of the FPGA circuitry 1900 of FIG. 19, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1900 of FIG. 19 may access and/or load the binary file to cause the FPGA circuitry 1900 of FIG. 19 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1900 of FIG. 19 to cause configuration and/or structuring of the FPGA circuitry 1900 of FIG. 19, or portion(s) thereof.

The FPGA circuitry 1900 of FIG. 19, includes example input/output (I/O) circuitry 1902 to obtain and/or output data to/from example configuration circuitry 1904 and/or external hardware 1906. For example, the configuration circuitry 1904 may be implemented by interface circuitry that may obtain a binary file, which may be implemented by a bit stream, data, and/or machine-readable instructions, to configure the FPGA circuitry 1900, or portion(s) thereof. In some such examples, the configuration circuitry 1904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1906 may be implemented by external hardware circuitry. For example, the external hardware 1906 may be implemented by the microprocessor 1800 of FIG. 18.

The FPGA circuitry 1900 also includes an array of example logic gate circuitry 1908, a plurality of example configurable interconnections 1910, and example storage circuitry 1912. The logic gate circuitry 1908 and the configurable interconnections 1910 are configurable to instantiate one or more operations/functions that may correspond to at least some of the machine readable instructions of FIGS. 5, 6, 7, 8, and/or 9 and/or other desired operations. The logic gate circuitry 1908 shown in FIG. 19 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1908 to enable configuration of the electrical structures and/or the logic gates to form circuits to perform desired operations/functions. The logic gate circuitry 1908 may include other electrical structures such as look-up tables (LUTs), registers (e.g., flip-flops or latches), multiplexers, etc.

The configurable interconnections 1910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1908 to program desired logic circuits.

The storage circuitry 1912 of the illustrated example is structured to store result(s) of the one or more of the operations performed by corresponding logic gates. The storage circuitry 1912 may be implemented by registers or the like. In the illustrated example, the storage circuitry 1912 is distributed amongst the logic gate circuitry 1908 to facilitate access and increase execution speed.

The example FPGA circuitry 1900 of FIG. 19 also includes example dedicated operations circuitry 1914. In this example, the dedicated operations circuitry 1914 includes special purpose circuitry 1916 that may be invoked to implement commonly used functions to avoid the need to program those functions in the field. Examples of such special purpose circuitry 1916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1900 may also include example general purpose programmable circuitry 1918 such as an example CPU 1920 and/or an example DSP 1922. Other general purpose programmable circuitry 1918 may additionally or alternatively be present such as a GPU, an XPU, etc., that can be programmed to perform other operations.

Although FIGS. 18 and 19 illustrate two example implementations of the programmable circuitry 1512, 1612, 1712 of FIGS. 15-17, many other approaches are contemplated. For example, FPGA circuitry may include an on-board CPU, such as one or more of the example CPU 1920 of FIG. 19. Therefore, the programmable circuitry 1512, 1612, 1712 of FIGS. 15-17 may additionally be implemented by combining at least the example microprocessor 1800 of FIG. 18 and the example FPGA circuitry 1900 of FIG. 19. In some such hybrid examples, one or more cores 1902 of FIG. 19 may execute a first portion of the machine readable instructions represented by the flowchart(s) of FIGS. 5, 6, 7, 8, and/or 9 to perform first operation(s)/function(s), the FPGA circuitry 1900 of FIG. 19 may be configured and/or structured to perform second operation(s)/function(s) corresponding to a second portion of the machine readable instructions represented by the flowcharts of FIGS. 5, 6, 7, 8, and/or 9, and/or an ASIC may be configured and/or structured to perform third operation(s)/function(s) corresponding to a third portion of the machine readable instructions represented by the flowcharts of FIGS. 5, 6, 7, 8, and/or 9.

It should be understood that some or all of the circuitry of FIG. 4 may, thus, be instantiated at the same or different times. For example, same and/or different portion(s) of the microprocessor 1800 of FIG. 18 may be programmed to execute portion(s) of machine-readable instructions at the same and/or different times. In some examples, same and/or different portion(s) of the FPGA circuitry 1900 of FIG. 19 may be configured and/or structured to perform operations/functions corresponding to portion(s) of machine-readable instructions at the same and/or different times.

In some examples, some or all of the circuitry of FIG. 4 may be instantiated, for example, in one or more threads executing concurrently and/or in series. For example, the microprocessor 1800 of FIG. 18 may execute machine readable instructions in one or more threads executing concurrently and/or in series. In some examples, the FPGA circuitry 1900 of FIG. 19 may be configured and/or structured to carry out operations/functions concurrently and/or in series. Moreover, in some examples, some or all of the circuitry of FIG. 4 may be implemented within one or more virtual machines and/or containers executing on the microprocessor 1800 of FIG. 18.

In some examples, the programmable circuitry 1512, 1612, 1712 of FIGS. may be in one or more packages. For example, the microprocessor 1800 of FIG. 18 and/or the FPGA circuitry 1900 of FIG. 19 may be in one or more packages. In some examples, an XPU may be implemented by the programmable circuitry 1512, 1612, 1712 of FIGS. 15-17 which may be in one or more packages. For example, the XPU may include a CPU (e.g., the microprocessor 1800 of FIG. 18, the CPU 1920 of FIG. 19, etc.) in one package, a DSP (e.g., the DSP 1922 of FIG. 19) in another package, a GPU in yet another package, and an FPGA (e.g., the FPGA circuitry 1900 of FIG. 19) in still yet another package.

A block diagram illustrating an example software distribution platform 2005 to distribute software such as the example machine readable instructions 1512, 1612, 1712 of FIGS. 15-17 to other hardware devices (e.g., hardware devices owned and/or operated by third parties from the owner and/or operator of the software distribution platform) is illustrated in FIG. The example software distribution platform 2005 may be implemented by any computer server, data facility, cloud service, etc., capable of storing and transmitting software to other computing devices. The third parties may be customers of the entity owning and/or operating the software distribution platform 2005. For example, the entity that owns and/or operates the software distribution platform 2005 may be a developer, a seller, and/or a licensor of software such as the example machine readable instructions 1512, 1612, 1712 of FIGS. 15-17. The third parties may be consumers, users, retailers, OEMs, etc., who purchase and/or license the software for use and/or re-sale and/or sub-licensing. In the illustrated example, the software distribution platform 2005 includes one or more servers and one or more storage devices. The storage devices store the machine readable instructions 1512, 1612, 1712 of FIGS. 15-17, which may correspond to the example machine readable instructions of FIGS. 5-9, as described above. The one or more servers of the example software distribution platform 2005 are in communication with an example network 2010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1512, 1612, 1712 of FIGS. 15-17 from the software distribution platform 2005. For example, the software, which may correspond to the example machine readable instructions of FIG. 5-9, may be downloaded to the example programmable circuitry platform 1500, which is to execute the machine readable instructions 1532 to implement the orchestrator controller circuitry 302. In some examples, one or more servers of the software distribution platform 2005 periodically offer, transmit, and/or force updates to the software (e.g., the example machine readable instructions 1532 of FIG. 15) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed that facilitate forced reservation for active probes and introduce a new workflow to perform a series of automated checks associated with edge platform-based workflows. In examples disclosed herein, a new workflow to perform a series of automated checks is introduced based on a predefined policy. For example, monitoring and automatic checks can be performed using network schemes (e.g., IPUs and switches) to include complex triggering rules. Furthermore, network schemes (e.g., IPUs and switches) can be programmed to monitor for multi-modal dependency. Additionally, methods and apparatus disclosed herein facilitate mapping a risk intent to deployment methods and mitigations. The risk assessment component builds models of risks overtime, based on observed risk occurrence, impact and meantime to repair and produces a model for faults in the orchestration layer, infrastructure layer, service orchestration layer, and/or monitor and analytics layer. In examples disclosed herein, intent-based orchestration is developed (e.g., intent driven orchestration). Intent driven orchestration allows for differentiation through software of smart orchestration platforms, including actuators and supporting components. For example, the intent driven orchestration-based framework disclosed herein allows for intents (e.g., assurance intents) to be mapped to provisioning and life management of resources to provide robust service assurance solutions for various purpose-engineered telco and edge platforms. In some examples, a user can express their intents in the form of objectives (e.g., as required latency, throughput, or reliability targets) and the orchestration stack determines what resources in the infrastructure are required to fulfill the objectives. Methods and apparatus disclosed herein provide for unique enabling of service assurance probes (e.g., active and/or passive) using intent driven orchestration. As such, methods and apparatus disclosed herein apply to a breadth of infrastructure components (e.g., including compute, graphics, IPU, memory and storage), thereby monitoring these components and bringing them into an integrated operation responsive to the needs of service owners and resource providers.

Example methods, apparatus, systems, and articles of manufacture for efficient execution of convolutional neural networks for compressed video sequences are disclosed herein. Further examples and combinations thereof include the following:

Example 1 includes an apparatus comprising interface circuitry, machine readable instructions, and programmable circuitry to utilize the machine readable instructions to reserve a probe on a compute device in a cluster of compute devices based on a request to satisfy a resource availability criterion associated with a resource of the cluster, apply a risk mitigation operation based on the resource availability criterion before deployment of a workload to the cluster, and monitor whether the criterion is satisfied based on data from the probe after deployment of the workload to the cluster.

Example 2 includes the apparatus of example 1, wherein the probe is used to at least one of (1) monitor a container or (2) validate workload performance.

Example 3 includes the apparatus of example 1, wherein the programmable circuitry is to perform a forced reservation of the probe.

Example 4 includes the apparatus of example 1, wherein when the resource availability criterion corresponds to a cluster level assurance intent to meet a target availability of the resource, the programmable circuitry is to generate a service risk profile, the service risk profile associated with the cluster level assurance intent.

Example 5 includes the apparatus of example 4, wherein the programmable circuitry is to map, based on the service risk profile, (1) an allowable risk associated with a risk tolerance profile to (2) a probability of risk occurrence on a domain of the compute device.

Example 6 includes the apparatus of example 1, wherein the risk mitigation includes adding capacity on failure conditions, applying an automatic remediation, or distributing risk in an orchestration layer or an analytics layer.

Example 7 includes the apparatus of example 1, wherein the programmable circuitry is to train a risk model based on at least one of an observed risk occurrence or a meantime to error repair.

Example 8 includes a method comprising reserving a probe on a compute device in a cluster of compute devices based on a request to satisfy a resource availability criterion associated with a resource of the cluster, applying a risk mitigation operation based on the resource availability criterion before deployment of a workload to the cluster, and monitoring whether the criterion is satisfied based on data from the probe after deployment of the workload to the cluster.

Example 9 includes the method of example 8, wherein the probe is used to at least one of (1) monitor a container or (2) validate workload performance.

Example 10 includes the method of example 8, further including performing a forced reservation of the probe.

Example 11 includes the method of example 8, wherein when the resource availability criterion corresponds to a cluster level assurance intent to meet a target availability of the resource, further including generating a service risk profile, the service risk profile associated with the cluster level assurance intent.

Example 12 includes the method of example 11, further including mapping, based on the service risk profile, (1) an allowable risk associated with a risk tolerance profile to (2) a probability of risk occurrence on a domain of the compute device.

Example 13 includes the method of example 8, wherein the risk mitigation includes adding capacity on failure conditions, applying an automatic remediation, or distributing risk in an orchestration layer or an analytics layer.

Example 14 includes the method of example 8, further including training a risk model based on at least one of an observed risk occurrence or a meantime to error repair.

Example 15 includes a non-transitory machine readable storage medium comprising instructions to cause programmable circuitry to at least reserve a probe on a compute device in a cluster of compute devices based on a request to satisfy a resource availability criterion associated with a resource of the cluster, apply a risk mitigation operation based on the resource availability criterion before deployment of a workload to the cluster, and monitor whether the criterion is satisfied based on data from the probe after deployment of the workload to the cluster.

Example 16 includes the non-transitory machine readable storage medium of example 15, wherein the probe is used to at least one of (1) monitor a container or (2) validate workload performance.

Example 17 includes the non-transitory machine readable storage medium of example 15, wherein the instructions are to cause the programmable circuitry to perform a forced reservation of the probe.

Example 18 includes the non-transitory machine readable storage medium of example 15, wherein when the resource availability criterion corresponds to a cluster level assurance intent to meet a target availability of the resource, the instructions are to cause the programmable circuitry to generate a service risk profile, the service risk profile associated with the cluster level assurance intent.

Example 19 includes the non-transitory machine readable storage medium of example 18, wherein the instructions are to cause the programmable circuitry to map, based on the service risk profile, (1) an allowable risk associated with a risk tolerance profile to (2) a probability of risk occurrence on a domain of the compute device.

Example 20 includes the non-transitory machine readable storage medium of example 15, wherein the instructions are to cause the programmable circuitry to train a risk model based on at least one of an observed risk occurrence or a meantime to error repair.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
interface circuitry;
machine readable instructions; and
programmable circuitry to utilize the machine readable instructions to:
reserve a probe on a compute device in a cluster of compute devices based on a request to satisfy a resource availability criterion associated with a resource of the cluster;
apply a risk mitigation operation based on the resource availability criterion before deployment of a workload to the cluster; and
monitor whether the criterion is satisfied based on data from the probe after deployment of the workload to the cluster.

2. The apparatus of claim 1, wherein the probe is used to at least one of (1) monitor a container or (2) validate workload performance.

3. The apparatus of claim 1, wherein the programmable circuitry is to perform a forced reservation of the probe.

4. The apparatus of claim 1, wherein when the resource availability criterion corresponds to a cluster level assurance intent to meet a target availability of the resource, the programmable circuitry is to generate a service risk profile, the service risk profile associated with the cluster level assurance intent.

5. The apparatus of claim 4, wherein the programmable circuitry is to map, based on the service risk profile, (1) an allowable risk associated with a risk tolerance profile to (2) a probability of risk occurrence on a domain of the compute device.

6. The apparatus of claim 1, wherein the risk mitigation includes adding capacity on failure conditions, applying an automatic remediation, or distributing risk in an orchestration layer or an analytics layer.

7. The apparatus of claim 1, wherein the programmable circuitry is to train a risk model based on at least one of an observed risk occurrence or a meantime to error repair.

8. A method comprising:
reserving a probe on a compute device in a cluster of compute devices based on a request to satisfy a resource availability criterion associated with a resource of the cluster;
applying a risk mitigation operation based on the resource availability criterion before deployment of a workload to the cluster; and
monitoring whether the criterion is satisfied based on data from the probe after deployment of the workload to the cluster.

9. The method of claim 8, wherein the probe is used to at least one of (1) monitor a container or (2) validate workload performance.

10. The method of claim 8, further including performing a forced reservation of the probe.

11. The method of claim 8, wherein when the resource availability criterion corresponds to a cluster level assurance intent to meet a target availability of the resource, further including generating a service risk profile, the service risk profile associated with the cluster level assurance intent.

12. The method of claim 11, further including mapping, based on the service risk profile, (1) an allowable risk associated with a risk tolerance profile to (2) a probability of risk occurrence on a domain of the compute device.

13. The method of claim 8, wherein the risk mitigation includes adding capacity on failure conditions, applying an automatic remediation, or distributing risk in an orchestration layer or an analytics layer.

14. The method of claim 8, further including training a risk model based on at least one of an observed risk occurrence or a meantime to error repair.

15. A non-transitory machine readable storage medium comprising instructions to cause programmable circuitry to at least:
reserve a probe on a compute device in a cluster of compute devices based on a request to satisfy a resource availability criterion associated with a resource of the cluster;
apply a risk mitigation operation based on the resource availability criterion before deployment of a workload to the cluster; and
monitor whether the criterion is satisfied based on data from the probe after deployment of the workload to the cluster.

16. The non-transitory machine readable storage medium of claim 15, wherein the probe is used to at least one of (1) monitor a container or (2) validate workload performance.

17. The non-transitory machine readable storage medium of claim 15, wherein the instructions are to cause the programmable circuitry to perform a forced reservation of the probe.

18. The non-transitory machine readable storage medium of claim 15, wherein when the resource availability criterion corresponds to a cluster level assurance intent to meet a target availability of the resource, the instructions are to cause the programmable circuitry to generate a service risk profile, the service risk profile associated with the cluster level assurance intent.

19. The non-transitory machine readable storage medium of claim 18, wherein the instructions are to cause the programmable circuitry to map, based on the service risk profile, (1) an allowable risk associated with a risk tolerance profile to (2) a probability of risk occurrence on a domain of the compute device.

20. The non-transitory machine readable storage medium of claim 15, wherein the instructions are to cause the programmable circuitry to train a risk model based on at least one of an observed risk occurrence or a meantime to error repair.
